(19) United States
(12) Patent Application Publication
(10) Pub. No.: US 2009/0009449 A1
(43) Pub. Date: Jan. 8, 2009

(54) DISPLAY DEVICE, ACTIVE MATRIX SUBSTRATE, LIQUID CRYSTALD DISPLAY DEVICE AND TELEVISION RECEIVER

(76) Inventors: Toshihisa Uchida, Suzuka-shi Mie (JP); Toshihide Tsubata, Tsu-shi Mie (JP)

Correspondence Address: HARNESS, DICKEY & PIERCE, P.L.C., P.O. BOX 8910, RESTON, VA, 20195, US

(21) Appl. No.: 12/087,863

(22) PCT Filed: Nov. 30, 2006
(86) PCT No.: PCT/JP2006/323966

§ 371 Date: Jul. 16, 2008

(30) Foreign Application Priority Data
Feb. 6, 2006 (JP) 2006-029043
Sep. 13, 2006 (JP) 2006-248558

(51) Int. Cl. G09G 3/36

(52) U.S. Cl. 345/87

(57) ABSTRACT

In one embodiment of a display device, pixels are arranged in matrix, and a first luminance area (high luminance area) and a second luminance area (low luminance area) which surrounds the first luminance area and has a luminance lower than that of the first luminance area can be formed in each pixel. The display device which can clearly display an image having a high spatial frequency and an active matrix substrate to be used for the display device are provided.

### TECHNICAL FIELD

The present invention relates to a display device such as a liquid crystal display device and to an active matrix substrate to be used for the display device.

### BACKGROUND ART

FIG. 36 illustrates a structure of a conventional active matrix substrate used for a liquid crystal display device. As illustrated in FIG. 36, an active matrix substrate 700 includes a plurality of scan signal lines 716 and a plurality of data signal lines 715 both lines provided so as to be intersected with each other, TFTs (Thin Film Transistors) 712 each located in the vicinity of each intersection of a data signal line 715 and a scan signal line 716, and pixel electrodes 717. A scan signal line 716 also works as a gate electrode of a TFT 712. A source electrode 719 of the TFT 712 is connected to the data signal line 715. A drain electrode 708 is connected to a pixel electrode 717 through a drain lead-out electrode 707. Between the drain lead-out electrode 707 and the pixel electrode 717, there is provided an insulating layer having a hole. This causes a provision of a contact hole 710 for connecting the drain lead-out electrode 707 and the pixel electrode 717. A pixel electrode 717 is a transparent electrode made of a member such as ITO, which allows light (back light) from the bottom of the matrix substrate to pass through.

In this active matrix substrate 700, the TFT 712 turns on (the source electrode 719 and the drain electrode 708 are in a conducting state) in response to a scan signal (gate ON voltage) supplied to the scan signal line 716. In this state, a data signal (signal voltage) supplied to the data signal line 715 is written into the pixel electrode 717, through the source electrode 719, the drain electrode 708, and the drain lead-out electrode 707. Note that a retentive capacity (Cs) wiring 718 has, for example, a function of preventing self-discharge of a liquid crystal layer during a turn off period of the TFT 712.

Note that, in the active matrix substrate 700, a pixel electrode 717 in each pixel has a uniform electric potential. Namely, when an active matrix substrate 700 is used in a liquid crystal display device, a display is carried out by pixels each of which has a substantially uniform luminance over its entire surface.

Note that patent document 1 discloses a structure in which each pixel is divided into two sub-pixels, i.e. an upper sub-pixel and a lower sub-pixel, one of them is intended to be a bright pixel having high luminance and the other is intended to be a dark pixel having low luminance. This intends to suppress viewing angle dependency of γ characteristic.

[Patent Document 1] Japanese Unexamined Patent Publication, Tokukai, No. 2004-62146 (date of publication: Feb. 26, 2004)

[Patent Document 2] Japanese Unexamined Patent Publication, Tokukai, No. 2004-78157 (date of publication: Mar. 11, 2004)

### DISCLOSURE OF INVENTION

However, when a display is carried out while maintaining a uniform luminance in each pixel, a problem arises that an image having a high spatial frequency blurs as illustrated in FIG. 21 (b). Even though the conventional structure disclosed in patent document 1 includes the upper and lower sub-pixels having different luminance cannot sufficiently make an improvement in display blurring of an image having a high spatial frequency.

The present invention is made in view of the foregoing problem. The objective of the present invention is to provide a display device which can clearly display an image having a high spatial frequency and an active matrix substrate to be used for the display device.

A display device of the present invention includes a plurality of pixels. Each of the pixels includes a first luminance area (high luminance area) and a second luminance area (low luminance area) which surrounds the first luminance area and has a luminance lower than that of the first luminance area. Namely, in this display device, each of the pixels includes (i) a first luminance area whose luminance can be controlled higher than that of the surrounding area, and (ii) a second luminance area, surrounding the first luminance area, whose luminance can be controlled lower than that of the first luminance area.

For example, in a display device expressed by the three primary colors (R, G, and B) of a simultaneous additive color mixture, each of the pixels is provided for each primary color. In this case, three pixels corresponding to the three primary colors are arranged in such as stripe, mosaic, or delta formation.

Thus, the display device of the present invention has pixels each of which has a pixel arrangement so that a low luminance area and a high luminance area surrounded by the low luminance area can be provided. This causes the high luminance area to deal with the total luminance or substantially the total luminance of an entire pixel (the light irradiation is carried out from the center part of a pixel) so that most of gradation displays are carried out. This allows an image having a high spatial frequency to be clearly displayed because of a great improvement in transfer characteristic in a high spatial frequency area.

In the display device of the present invention, each of the pixels may include a first switching element, a second switching element, a first sub-pixel electrode connected to the first switching element, and a second sub-pixel electrode which surrounds the first sub-pixel electrode and is connected to the second switching electrode.

The display device of the present invention is preferably arranged such that the first and the second luminance areas have the same gravity center. This structure can recreate the position information corresponding to the image signal correctly and realize smooth graphic display without jaggy edges.

The display device of the present invention is preferably arranged such that a lowest luminance area is provided between the first luminance area (high luminance area) and the second luminance area (low luminance area). The lowest luminance area (for example, formed by shielding light in periphery of the high luminance area) enables to prevent a decline in contrast due to leakage of light. Unlike the above arrangement, it is also possible to arrange the first luminance area (high luminance area) and the second luminance area (low luminance area) adjacent to each other without having the lowest luminance area therebetween.

In the display device of the present invention including an active matrix substrate and a color filter substrate, the lowest luminance area may be formed at least one of a black matrix in the color filter substrate, and a light-shielding body in the active matrix substrate. This allows a reduction in manufacturing processes and manufacturing cost because it is not necessary to form an additional light-shielding body (for preventing light leakage from the periphery of the high luminance area).

In the display device of the present invention, the first switching element and the second switching element may be connected to the same data signal line. Alternatively, the first switching element and the second switching element may be connected to the same scan signal line. In this case, for example, a first retentive capacity wiring, the first sub-pixel electrode and the first retentive capacity wiring defining capacitance, and a second retentive capacity wiring, the second sub-pixel electrode and the second retentive capacity wiring defining capacitance, are provided. Further, electric potentials of the first retentive capacity wiring and the second retentive capacity wiring are set to be controlled independently. Specifically, the first retentive capacity wiring and the second retentive capacity wiring are applied an opposite-phase signal voltage with each other. This makes easier to control an effective voltage of each first and second sub-pixel electrode and to form the high luminance area and the low luminance area. With this structure, the first retentive capacity wiring and the second retentive capacity wirings may be controlled to have waveforms whose phase shift is 180°. Also, the first and the second retentive capacity wiring may be controlled to have an electric potential which increases or decreases after each of the first and the second switching elements turns off and is then maintained until each of the first and the second switching elements turns off in the following frame.

Namely, the first retentive capacity wiring is controlled to have an electric potential which increases after each of the switching elements turns off and is then maintained until each of the switching elements turns off in the following frame. At the same time, the second retentive capacity wiring is controlled to have an electric potential which decreases after each of the switching elements turns off and is then maintained until each of the switching elements turns off in the following frame. Alternatively, the first retentive capacity wiring is controlled to have an electric potential which decreases after each of the switching elements turns off and is then maintained until each of the switching elements turns off in the following frame. At the same time, the second retentive capacity wiring is controlled to have an electric potential which increases after each of the switching elements turns off and is then maintained until each of the switching elements turns off in the following frame. In this case, increasing of the electric potential of the first retentive capacity wiring is in sync with decreasing of the electric potential of the second retentive capacity wiring, or decreasing of the electric potential of the first retentive capacity wiring is in sync with increasing of the electric potential of the second retentive capacity wiring. Alternatively, increasing of the electric potential of the first retentive capacity wiring and decreasing of the electric potential of the second retentive capacity wiring are shifted by one horizontal period, or decreasing of the electric potential of the first retentive capacity wiring and increasing of the electric potential of the second retentive capacity wiring are shifted by one horizontal period.

The display device of the present invention may be arranged such that the first switching element and the second switching element are connected to the first and the second scan signal lines, respectively. In this case, an on-pulse signal applied to the first scan signal line and an on-pulse signal applied to the second scan signal line may not temporally overlap, or may overlap for a certain period of time but become in their off-states at different timing, respectively.

For example, the on-pulse signal applied to the first scan signal line and the on-pulse signal applied to the second scan signal line simultaneously become in their on-states but the on-pulse signal applied to the first scan signal line becomes in its off-state earlier than the on-pulse signal applied to the second scan signal line. Also, an electric potential applied to the data signal line changes in sync with timing at which one of the on-pulse signals becomes in its off-state earlier than the other or after the timing. As a result, the second sub-pixel electrode, which is connected to the second switching element controlled by the second scan signal line, is charged in a good condition because after an electric potential is once applied to the second sub-pixel electrode, an electric potential to be written is applied to the second sub-pixel electrode. This is especially effective (i) in cases where the polarity of the signal potential applied to the data signal line is inverted for every horizontal period (namely, in cases where a distortion of the signal potential is large), such as the dot inversion driving and the H line inversion driving or (ii) in cases where the second sub-pixel electrode has a large area (namely, in cases where it takes long for charging to be carried out). Further, it is possible to suppress a driving frequency of the scan signal because the on-pulse signal has a longer cycle.

Note that the polarity of the same data signal line is inverted for every horizontal period.

In the display device of the present invention, the first switching element and the second switching element may be connected to independent first and second data signal lines, respectively. In this case, the first luminance area and the second luminance area are formed by applying different signal electric potentials to the first and the second data signal lines, respectively.

The active matrix substrate of the present invention includes a plurality of pixel regions. Each of the pixel regions includes a first switching element, a second switching element, a first sub-pixel electrode connected to the first switching element, a second sub-pixel electrode which surrounds the first sub-pixel electrode and is connected to the second switching element.

When the active matrix substrate of the present invention is used for a display device, it is possible to form a high luminance area and a low luminance area which surrounds the low luminance area in each pixel corresponding to each pixel region. Namely, this causes the high luminance area to deal with the total luminance or substantially the total luminance of an entire pixel (the light irradiation is carried out from the center part of a pixel) so that most of gradation displays are carried out. Thus, the display device including this active matrix substrate can clearly display an image having a high spatial frequency because of a great improvement in transfer characteristic in a high spatial frequency area.

The active matrix substrate of the present invention may be arranged such that the first switching element and the second switching element are connected to the same scan signal line. Alternatively, the first switching element and the second switching element may be connected to independent first and second data signal lines, respectively.

The active matrix substrate of the present invention may include a data signal line provided to each of the pixel regions, the first and second switching elements being connected to the single data signal line, a first retentive capacity wiring, the first sub-pixel electrode and the first retentive capacity wiring defining capacitance, a second retentive capacity wiring, the second sub-pixel electrode and a second retentive capacity wiring defining capacitance.

The active matrix of the present invention substrate may include a data signal line provided to each of the pixel regions, the first and second switching elements being connected to the single data signal line, a first retentive capacity wiring, the first sub-pixel electrode and the first retentive capacity wiring defining capacitance, a second retentive capacity wiring, the second sub-pixel electrode and a second retentive capacity wiring defining capacitance.

The active matrix substrate of the present invention may include independent first and second data signal lines provided to the pixel regions respectively, the first data signal line connected to the first switching element, and the second signal line connected to the second switching element.

In the active matrix substrate of the present invention, a light-shielding body may be provided so that the light-shielding body, a boundary area between the first sub-pixel electrode and the second sub-pixel electrode overlap each other. Thus, it is possible to avoid a decline in contrast due to leakage of light from (gap area) in the vicinity of the boundary area between the first and second pixel electrodes. Further, in an active matrix substrate including a light shielding body, no decline occurs in light-shielding effect due to the misalignment in combining of a color filter substrate like in cases where a light-shielding body is provided on a color filter substrate. Note that a part of the wiring from the first switching element or the second switching element and a boundary area between the first sub-pixel electrode and the second sub-pixel electrode may overlap each other. Also, a part of the scan signal line and a boundary area between the first sub-pixel electrode and the second sub-pixel electrode may overlap each other. In this case, the scan signal line may be wired in a middle part of a pixel in a frame shape so that the scan signal line and the boundary area overlap each other. Note that a part of the first retentive capacity wiring and a boundary area between the first sub-pixel electrode and the second sub-pixel electrode may overlap each other. In this case, the first retentive capacity wiring may be wired in a middle part of a pixel in a frame shape so that the first retentive capacity wiring and the boundary area overlap each other.

Also, a display device of the present invention is characterized by including the active matrix substrate.

Also, a liquid crystal display device of the present invention including the active matrix substrate, a back light radiating a plurality of colors in a time division, and this liquid crystal display device is characterized by performing a field sequential display. With this structure, for example, three primary colors (R, G, and B) are displayed in one pixel consecutively (two or more colors will never be displayed at a time). This structure allows the display quality to be improved because there is no dislocation of the color information. Further, this allows the cost reduction because no color filter is required.

A television receiver of the present invention is characterized by including the display device, and a tuner member for receiving the television broadcasting.

As explained above, the display device of the present invention can clearly display an image having a high spatial frequency. Also, when this active matrix substrate is used for a display device, it is possible to form a high luminance area and a low luminance area which surrounds the high luminance area in each pixel corresponding to each pixel region so that an image having a high spatial frequency can be displayed clearly.

### BRIEF DESCRIPTION OF DRAWINGS

FIG. 1 is a perspective plan view illustrating a structure of an active matrix substrate in accordance with an embodiment of the present invention.

FIG. 2 is an equivalent circuit diagram of an active matrix substrate in accordance with the present embodiment.

FIG. 3 is an equivalent circuit diagram of a liquid crystal display having an active matrix substrate in accordance with the present embodiment.

FIG. 4 is a perspective plan view illustrating a configuration example of an active matrix substrate in accordance with the present embodiment.

FIG. 5 is a perspective plan view illustrating another configuration example of an active matrix substrate in accordance with the present embodiment.

FIG. 6 is an equivalent circuit diagram of another active matrix substrate in accordance with the present embodiment.

FIG. 7 is an equivalent circuit diagram of a further active matrix substrate in accordance with the present embodiment.

FIG. 8 is a perspective plan view illustrating a configuration example of a further active matrix substrate in accordance with the present embodiment.

FIG. 9 is a perspective plan view illustrating a configuration example of still a further active matrix substrate in accordance with the present embodiment.

FIG. 10 is a perspective plan view illustrating a configuration example of another active matrix substrate in accordance with the present embodiment.

FIG. 11 is a perspective plan view illustrating a configuration example of yet another active matrix substrate in accordance with the present embodiment.

FIG. 12 is an equivalent circuit diagram of still a further active matrix substrate in accordance with the present embodiment.

FIG. 13 is a timing chart illustrating a driving method of an active matrix substrate in accordance with the present embodiment.

FIG. 14 is a schematic view illustrating an arrangement of image signals.

FIG. 15 (a) is a schematic view illustrating an arrangement of each luminance area in an active matrix substrate in accordance with the present embodiment.

FIG. 15 (b) is a reference drawing explaining FIG. 15 (a).

FIG. 16 is a block diagram illustrating an arrangement of a liquid crystal display device in accordance with an embodiment of the present invention.

FIG. 17 (a) is a schematic view illustrating a pixel structure in a field sequential method.

FIG. 17 (b) is a schematic view illustrating a pixel structure in a field sequential method.

FIG. 18 is a schematic view illustrating a driving method in a field sequential method.

FIG. 19 (a) is a schematic view illustrating an advantage of a field sequential method.

FIG. 19 (b) is a schematic view illustrating another advantage of a field sequential method.

FIG. 20 is a block diagram illustrating an arrangement of a liquid crystal display device in a field sequential method.

FIG. 21 (a) is a schematic view illustrating a case when a spatial frequency characteristic is low.

FIG. 21 (b) is a schematic view illustrating a case when a spatial frequency characteristic is high.

FIG. 22 (a) is a schematic view of a display device having a big lighting area.

FIG. 22 (b) is a schematic view of a display device having a small lighting area.

FIG. 23 is a graph showing a transfer characteristic.

FIG. 24 is a block diagram illustrating a structure of a television receiver in accordance with an embodiment of the present invention.

FIG. 25 is a perspective view illustrating a structure of a television receiver in accordance with an embodiment of the present invention.

FIG. 26 is a graph showing an example of a luminance distribution of the display device.

FIG. 27 is a graph showing an example of another luminance distribution of the display device.

FIG. 28 is a perspective plan view illustrating a configuration example of an active matrix substrate in accordance with the present embodiment.

FIG. 29 is a perspective plan view illustrating a configuration example of another active matrix substrate in accordance with the present embodiment.

FIG. 30 is an equivalent circuit diagram of the active matrix substrate illustrated in FIG. 29.

FIG. 31 is a timing chart illustrating another driving method of an active matrix substrate in accordance with the present embodiment.

FIG. 32 is a timing chart illustrating a further driving method of an active matrix substrate in accordance with the present embodiment.

FIG. 33 is a timing chart illustrating still a further driving method of an active matrix substrate in accordance with the present embodiment.

FIG. 34 is a cross-section view illustrating a structure of a liquid crystal panel in accordance with an embodiment of the present invention.

FIG. 35 is a timing chart illustrating yet another driving method of an active matrix substrate in accordance with the present embodiment.

FIG. 36 is a plan view illustrating a structure of a conventional active matrix substrate.

### EXPLANATION OF REFERENCE NUMERALS

5 pixel region
12a, 12b TFT
15 data signal line
16 scan signal line
17a first sub-pixel electrode
17b second sub-pixel electrode
11a, 11b contact hole
20 first retentive capacity wiring
21 second retentive capacity wiring

### BEST MODE FOR CARRYING OUT THE INVENTION

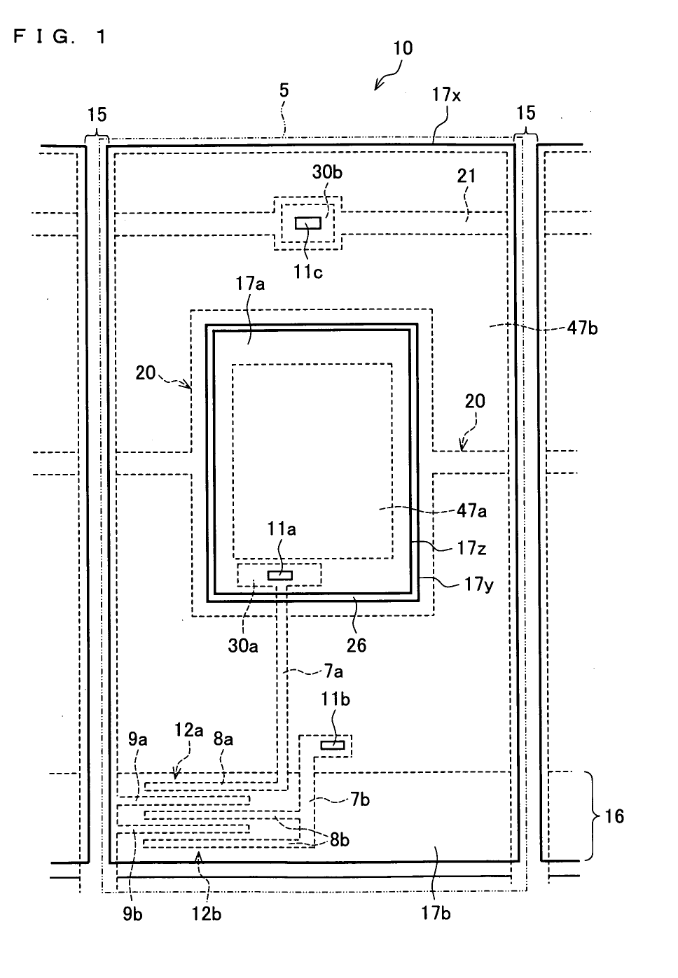

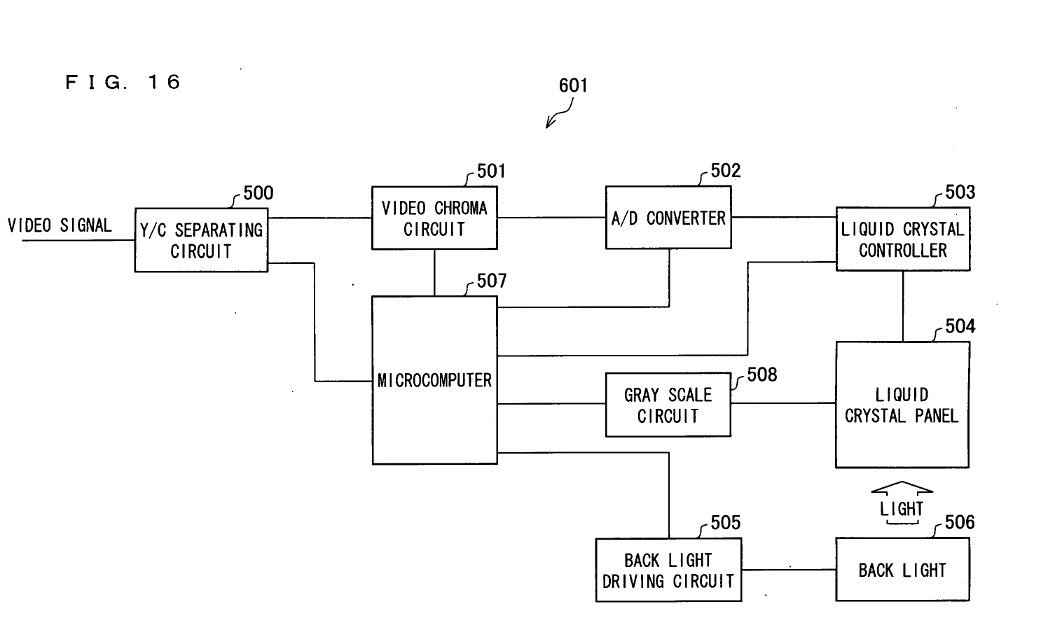

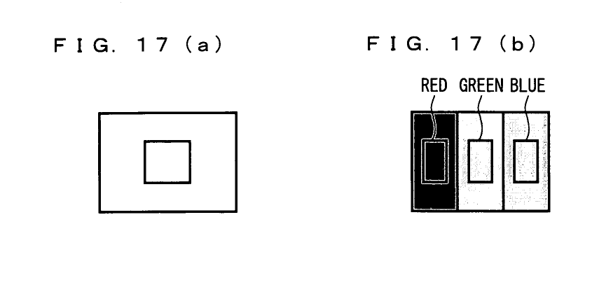

The following description deals with an embodiment of the present invention with reference to the FIG. 1 through FIG. 35.

FIG. 1 is a perspective plain view illustrating a structure of an active matrix substrate in accordance with an embodiment of the present invention. As illustrated in FIG. 1, an active matrix substrate 10 includes a pixel region 5 arranged in matrix, a scan signal line 16 (along a row direction, in a transverse direction in FIG. 1) and a data signal line 15 (along a column direction, in an up-and-down direction in this figure) both lines provided so as to be intersected with each other, first retentive capacity wiring 20, and second retentive capacity wiring 21.

Each of the pixel regions 5 includes a first TFT (Thin Film Transistor) 12a, a second TFT 12b, a first sub-pixel electrode 17a, and a second sub-pixel electrode 17b.

The second sub-pixel electrode 17b has a rectangular shape which is hollowed out to have a hollow part. The second sub-pixel electrode 17b has (i) an outer rim 17x which has a big rectangular shape and (ii) an inner rim (outer rim of the hollow part) 17y which has a small rectangular shape. Inside the inner rim 17y, there is provided the first sub-pixel electrode 17a having a rectangular shape. Namely, an active matrix substrate of the present embodiment has a structure in which the first sub-pixel electrode 17a is surrounded by the second sub-pixel electrode 17b.

There is provided a gap area 26 between an outer rim 17z of the first sub-pixel electrode 17a and the inner rim 17y of the second sub-pixel electrode 17b. The first retentive capacity wiring 20 is wired in a frame shape so that the first retentive capacity wiring 20, the gap area 26, an adjacent area of the outer rim of the first sub-pixel electrode 17a, and an adjacent area of the inner rim of the second sub-pixel electrode 17b overlap each other. Also, an upper electrode 30a for forming a retentive capacity is provided so that the upper electrode 30a, the first retentive capacity wiring 20 and the first sub-pixel electrode 17a overlap each other. The upper electrode 30a and the first sub-pixel electrode 17a are connected via a contact hole 11a. Also, (i) a lower end part of the second sub-pixel electrode 17b (one end part in the column direction) and (ii) a scan signal line 16 which is provided to extend in a row direction (in a transverse direction in the figure) overlap each other. With the arrangement, the first retentive capacity wiring 20 allows a black display area (lowest luminance area) to be formed in a flame shape between the high luminance area 47a (first luminance area) and the low luminance area 47b (second luminance area).

A first TFT 12a and a second TFT 12b are provided in the vicinity of each intersection of a data signal line 15 and a scan signal line 16. A source electrode 9a of the first TFT 12a and a source electrode 9b of the second TFT 12b are connected to a data signal line 15. A drain electrode 8a of the first TFT 12a is connected to the upper electrode 30a via a drain lead-out wiring 7a, and a drain electrode 8b of the second TFT 12b is connected to the second sub-pixel electrode 17b via a drain lead-out wiring 7b and a contact hole 11b.

Further, the second retentive capacity wiring 21 is provided so as to get across a part of an upper part of the second sub-pixel electrode 17b (provided on an opposite side where the TFT 12a and TFT 12b are provided, with respect to the first pixel electrode 17a) in a row direction (in a transverse direction in the figure). An upper electrode 30b for forming a retentive capacity is provided so that the upper electrode 30b, the second retentive capacity wiring 21 and the second sub-pixel electrode 17b overlap each other. The upper electrode 30b is connected to the second sub-pixel electrode 17b via a contact hole 11c.

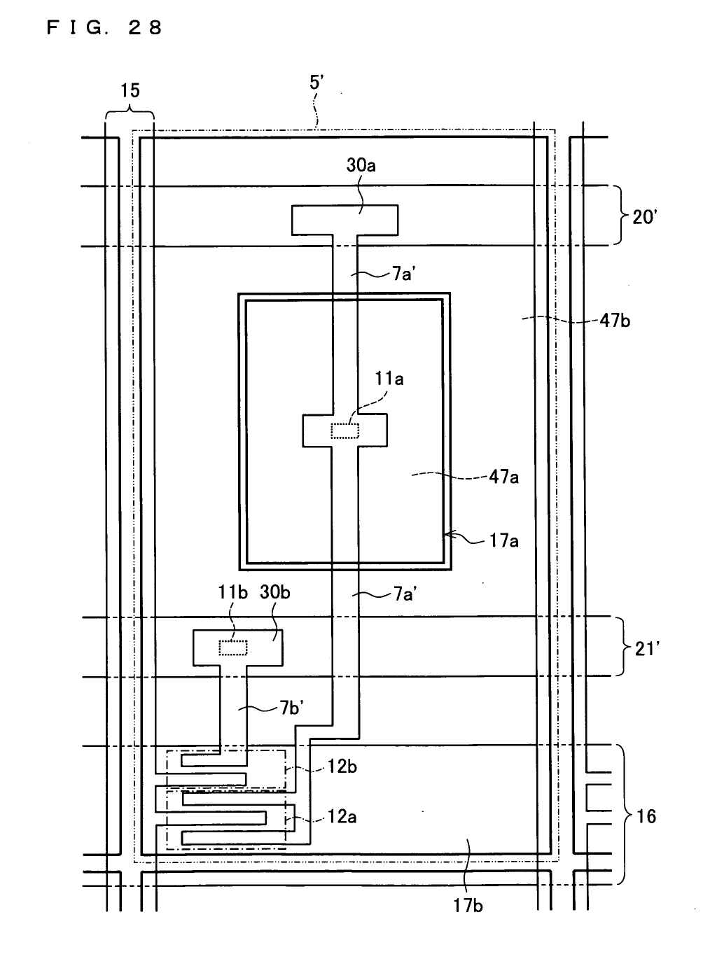

FIG. 1 illustrates that the first retentive capacity wiring 20 is wired in a frame shape so that the gap area 26, the adjacent area of the outer rim of the first sub-pixel electrode 17a, and the adjacent area of the inner rim of the second sub-pixel electrode 17b overlap each other. However, the present embodiment is not limited to this. For example, as a pixel region 5′ illustrated in FIG. 28, first and second retentive capacity wiring 20′ and 21′ are provided so that a first sub-pixel electrode 17a is between the first and second retentive capacity wiring 20′ and 21′ in a row direction (in a transverse direction in FIG. 28). Also, a drain electrode of a first TFT 12a is connected to an upper electrode 30a for forming a retentive capacity, which upper electrode 30a is provided on the first retentive capacity wiring 20′, via a drain lead-out wiring 7a′, which extends under the first sub-pixel electrode 17a. Further, the drain lead-out wiring 7a′ is connected to the first sub-pixel electrode 17a, via a contact hole 11a. Also, a drain electrode of a second TFT 12b is connected to an upper electrode 30b for forming a retentive capacity, which upper electrode 30b is provided on the second retentive capacity wiring 21′, via a drain lead-out wiring 7b′. The upper electrode 30b is connected to the second sub-pixel electrode 17b, via a contact hole 11b. With the structure illustrated in FIG. 28, the lowest luminance area is not formed, by a light-shielding body, between a high luminance area 47a and a low luminance area 47b. This causes the high luminance area 47a and the low luminance area 47b to be adjacent to each other.

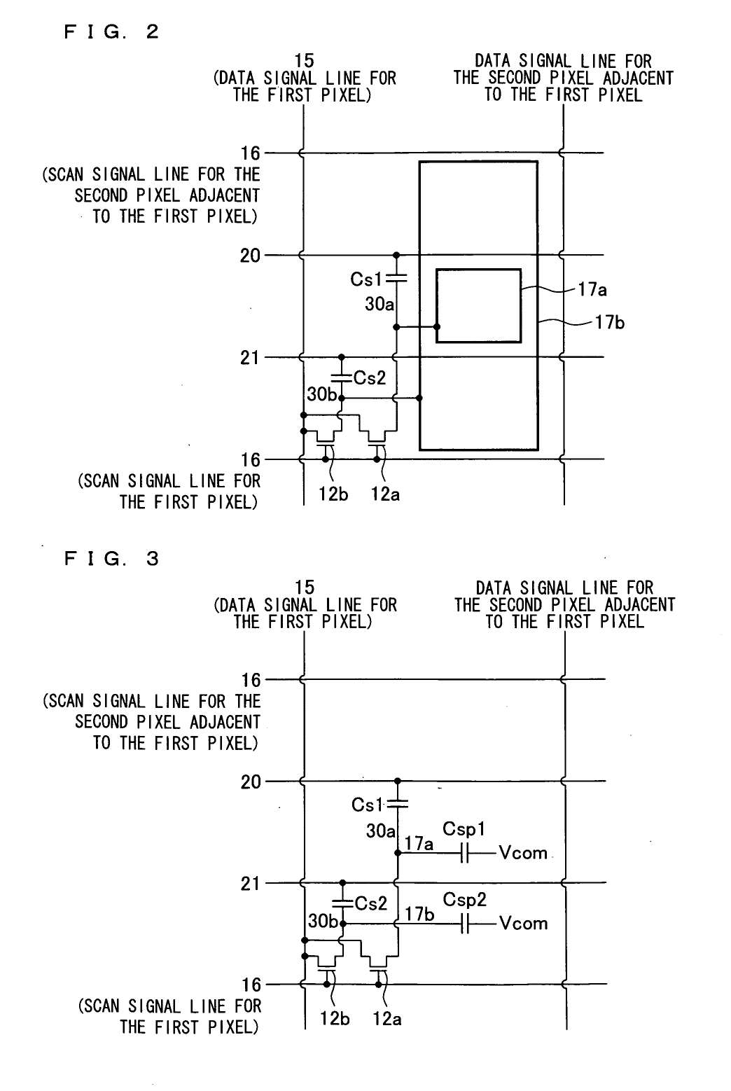

A circuit illustrated in FIG. 2 is realized by the structure illustrated in FIG. 1. Specifically, the first sub-pixel electrode 17a is connected to the data signal line 15, via the first TFT 12a, and the second sub-pixel electrode 17b is connected to the data signal line 15, via the second TFT 12b. Note that gates of the first TFT 12a and the second TFT 12b are connected to the scan signal line 16. A retentive capacitance Cs1 is formed between the first retentive capacity wiring 20 and the upper electrode 30a connected to the first sub-pixel electrode 17a. A retentive capacitance Cs2 is formed between the second retentive capacity wiring 21 and the upper electrode 30b connected to the second sub-pixel electrode 17b.

As described later, Cs signals (auxiliary capacitance counter voltage) having different phases are applied to the first retentive capacity wiring 20 and the second retentive capacity wiring 21 in FIG. 2, respectively. When each pixel is driven based on a dot inversion driving or a V line inversion driving, electric potentials having reverse polarities to each other are applied to adjacent two pixels provided in a row direction (in a transverse direction in the figure), respectively. Therefore, in this case, the first retentive capacity wiring 20 of a first pixel is connected to the second retentive capacity wiring 21 of a second pixel adjacent to the first pixel, and the second retentive capacity wiring 21 of the first pixel is connected to the first retentive capacity wiring 20 of the second pixel.

FIG. 3 illustrates an equivalent circuit of the liquid crystal display device (liquid crystal panel) including an active matrix substrate 10. As illustrated in FIG. 3, a first sub-pixel capacitance Csp1 is formed by a first sub-pixel electrode 17a, a counter electrode (Vcom), and a liquid crystal layer between the electrodes. A second sub-pixel capacitance Csp2 is formed by a second sub-pixel electrode 17b, a counter electrode (Vcom), and a liquid crystal layer between the electrodes.

The following description deals with a driving method of a liquid crystal display device in accordance with an embodiment of the present invention.

In an embodiment of the present invention, a display signal voltage is applied, via a single data signal line, to the first sub-pixel electrode and the second sub-pixel electrode, which surrounds the first sub-pixel electrode. Thereafter, while turning off the each TFT, the voltages of the first and second retentive capacity wiring are changed so as to be different from each other. As a result, each pixel includes a high luminance area caused by a first sub-pixel capacitance Csp1 and a low luminance area caused by a second sub-pixel capacitance Csp2. The high luminance area is surrounded by the low luminance area. With this arrangement, a single data signal line supplies a display signal voltage to two sub-pixel electrodes. This gives rise to the following advantage. Namely, it is not necessary to increase the number of data signal lines and the number of source drivers for driving the data signal lines.

FIG. 13 is a timing chart illustrating a voltage of each part in the circuit in FIG. 3. Vg indicates a voltage of the scan signal line (gate electrodes of the first and second TFTs). Vs indicates a voltage of the data signal line (source voltage). Vcs1 indicates a voltage of the first retentive capacity wiring. Vcs 2 indicates a voltage of the second retentive capacity wiring. Vlc1 indicates a voltage of the first sub-pixel electrode. Vlc2 indicates a voltage of the second sub-pixel electrode. In a liquid crystal display device, alternate current driving such as a frame inversion, a line inversion, or a dot inversion is generally used so that the liquid crystal is not polarized. Specifically, (i) a source voltage having a plus polarity (Vsp) is applied to a middle value of the source voltage (Vsc) during the n-th frame, (ii) a source voltage having a minus polarity (Vsn) is applied to Vsc during the (n+1)-th frame, and (iii) a dot inversion is carried out for every frame. Further, voltages of the first and second retentive capacity wiring are oscillated so as to have an amplitude voltage Vad and have a 180° difference in phase shift.

The following description deals with how each voltage waveform in the n-th frame in FIG. 13 changes over time.

Firstly, it is assumed that, at time T0, Vcs1=(Vcom−Vad) and Vcs2=(Vcom+Vad) are satisfied. Note that Vcom is a voltage of a counter electrode.

At time T1, Vg is changed from VgL to VgH and each TFT turns on. As a result, Vlc1 and Vlc2 increase to Vsp. Retentive capacitances Cs1, Cs2 and sub-pixel capacitances Csp 1, Csp 2 are charged, respectively.

At time T2, Vg is changed from VgH to VgL, and each TFT turns off. The retentive capacitances Cs1, Cs2 and sub-pixel capacitances Csp1, Csp2 are electrically insulated from a data signal line. Right after this, pull-in effect is caused by the influence of a parasitic capacity or other influence. As a result, the following equations are satisfied: Vlc1=(Vsp−Vd1), and Vlc2=(Vsp−Vd2).

At time T3, Vcs1 is changed from (Vcom−Vad) to (Vcom+Vad), and Vcs2 is changed from (Vcom+Vad) to (Vcom−Vad). As a result, the following equations are satisfied: Vlc1=(Vsp−Vd1+2×K×Vad), and Vlc2=(Vsp−Vd2−2×K×Vad). Note that K=Ccs/(Clc+Ccs) is satisfied, where Ccs is a capacity value of each retentive capacitance (Cs1 and Cs2), and Clc is a capacity value of each sub-pixel capacitance (Csp1 and Csp2).

At time T4, Vsc1 is changed from (Vcom+Vad) to (Vcom−Vad), and Vcs2 is changed from (Vcom−Vad) to (Vcom+Vad). As a result, the following equations are satisfied: Vlc1=(Vsp−Vd1), and Vlc2=(Vsp−Vd2).

At time T5, Vsc1 is changed from (Vcom−Vad) to (Vcom+Vad), and Vsc2 is changed from (Vcom+Vad) to (Vcom−Vad). As a result, the following equations are satisfied: Vlc1=(Vsp−Vd1+2×K×Vad), and Vlc2=(Vsp−Vd2−2×K×Vad).

After that, the processes made during time T4 and time T5 are repeated for every integral multiple of a horizontal scan period 1H until the next satisfying of Vg=Vgh causes the writing to be carried out. Therefore, Vlc1 has an effective value of (Vsp−Vd1+K×Vad) and Vlc2 has an effective value of (Vsp−Vd2−K×Vad).

According to this, effective voltages (V1 and V2) applied, during the n-th frame, to the respective sub-pixel capacitance (first sub-pixel capacitance Csp1 and second sub-pixel capacitance Csp2) become V1=(Vsp−Vd1+K×Vad−Vcom) and V2=(Vsp−Vd2−K×Vad−Vcom), respectively. This causes formation of (i) a high luminance area caused by the first sub-pixel capacitance Csp1 and (ii) a low luminance area caused by the second sub-pixel capacitance Csp2, which low luminance area surrounds the high luminance area.

The following description deals with how each voltage waveform in the (n+1)-th frame changes over time.

Firstly, it is assumed that, at time T0, Vcs1=(Vcom+Vad) and Vcs2=(Vcom−Vad) are satisfied. Note that Vcom is a voltage of a counter electrode.

At time T1, Vg is changed from VgL to VgH, and each TFT turns on. As a result, Vlc1 and Vlc2 fall to Vsn. Retentive capacitances Cs1, Cs2 and sub-pixel capacitances Csp1, Csp2 are changed, respectively.

At time T2, Vg is changed from VgH to VgL and each TFT turns off. The retentive capacitances Cs1, Cs2 and the sub-pixel capacitances Csp1, Csp2 are electrically insulated from a data signal line. Right after this, pull-in effect caused by the influence of a parasitic capacity or other influence. As a result, the following equations are satisfied: Vlc1=(Vsn−Vd1), and Vlc2=(Vsn−Vd2).

At time T3, Vcs1 is changed from (Vcom+Vad) to (Vcom−Vad), and Vcs2 is changed from (Vcom−Vad) to (Vcom+Vad). As a result, the following equations are satisfied: Vlc1=(Vsn−Vd1+2×K×Vad), and Vlc2=(Vsn−Vd2−2×K×Vad). Note that K=Ccs/(Clc+Ccs) is satisfied, where Ccs is a capacity value of each retentive capacitance (Cs1 and Cs2), and Clc is a capacity value of each sub-pixel capacitance (Csp1 and Csp2).

At time T4, Vcs1 is changed from (Vcom−Vad) to (Vcom+Vad) and Vcs2 is changed from (Vcom+Vad) to (Vcom−Vad). As a result, the following equations are satisfied: Vlc1=(Vsn−Vd1), and Vlc2=(Vsn+Vd2).

At time T5, Vcs1 is charged from (Vcom+Vad) to (Vcom−Vad) and Vcs 2 is charged from (Vcom−Vad) to (Vcom+Vad). As a result, the following equations are satisfied: Vlc1=(Vsn−Vd1−2×K×Vad), and Vlc2=(Vsn−Vd2+2×K×Vad).

After that, the process made during time T4 and time T5 are repeated for every integral multiple of a horizontal scan period 1H until the next satisfying of Vg=Vgh causes the writing to be carried out. Therefore, Vlc1 has an effective value of (Vsn−Vd1−K×Vad) and Vlc2 has an effective value of (Vsn−Vd2+K×Vad).

According to this, effective voltages (V1 and V2) applied, during (n+1)-th frame, to the respective sub-pixel capacitance (Csp1 and Csp2) become V1=(Vsn−Vd1−K×Vad−Vcom) and V2=(Vsn−Vd2+K×Vad−Vcom), respectively. This causes formation of (i) a high luminance area caused by the first sub-pixel capacitance Csp1 and (ii) a low luminance area caused by the second sub-pixel capacitance Csp2, which low luminance area surrounds the high luminance area.

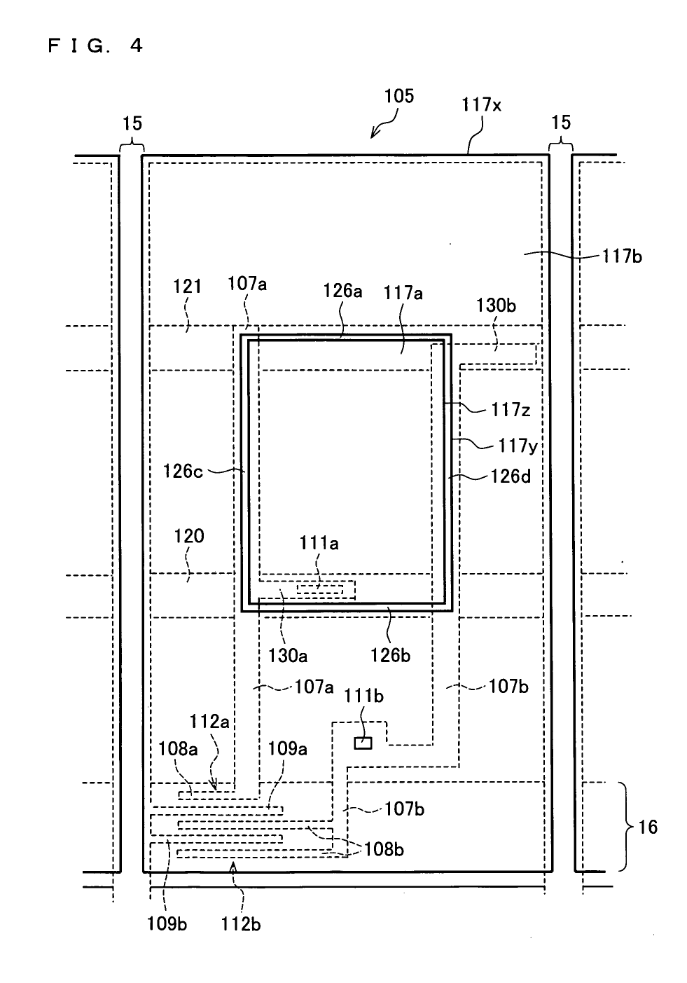

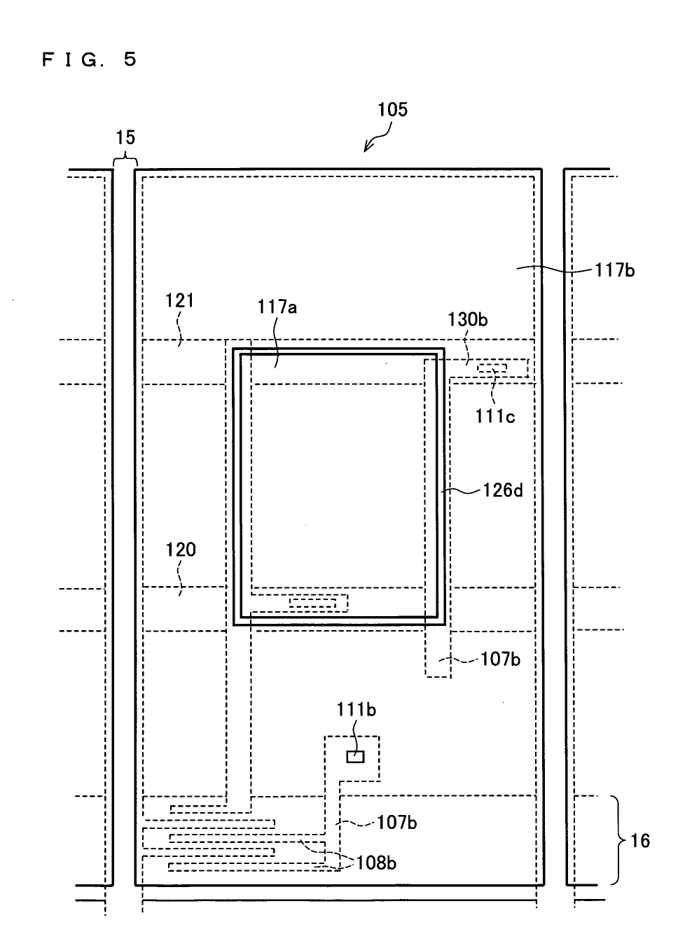

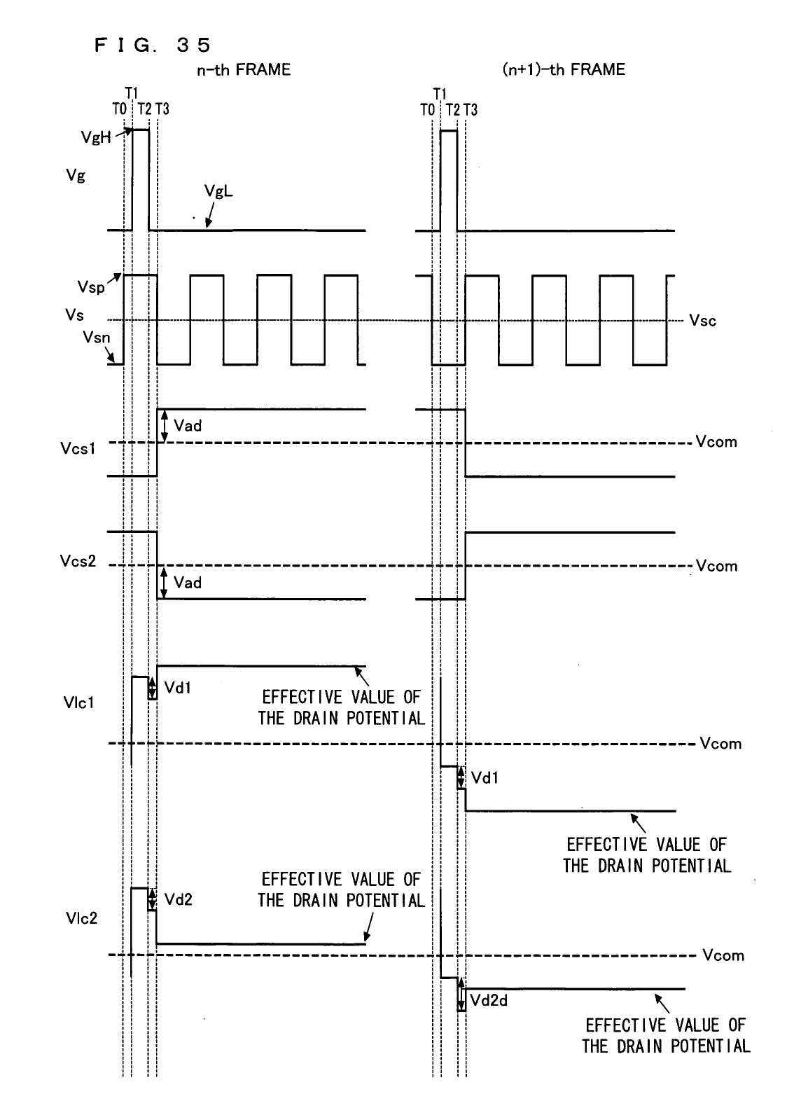

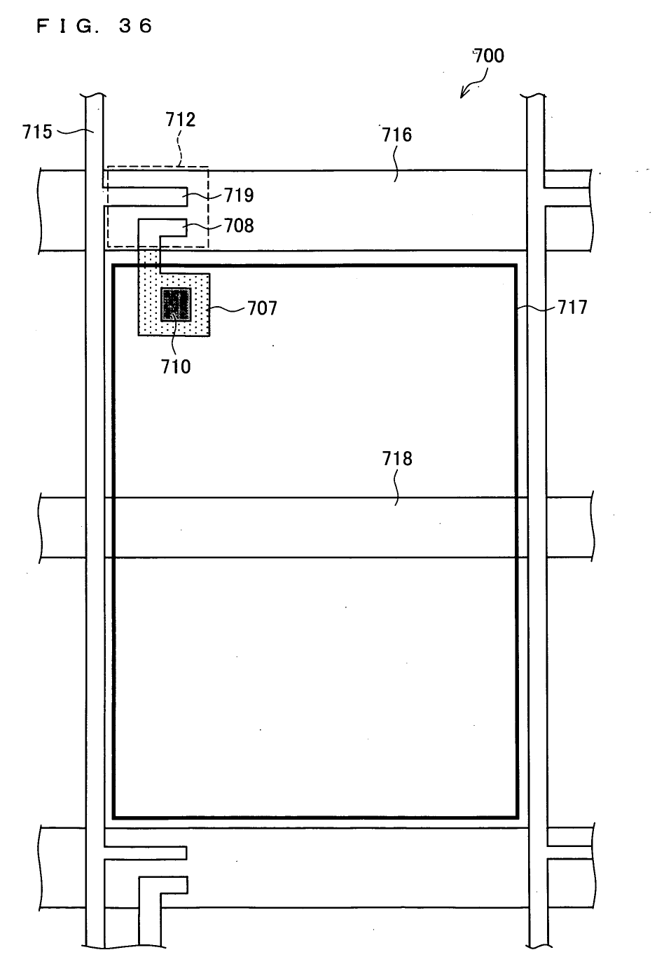

As illustrated in FIG. 35, it is possible for Vcs1 to have a waveform in which “High” (or “Low”) is maintained at T3 coming right after Vg became “L” (each TFT 12a and 12b turned off) at T2. Similarly, it is possible for Vcs2 to have a waveform in which “Low” (or “High”) is maintained at T3 coming right after Vg became “L” at T2. Namely, after each transistor turned off, it is possible to control an electric potential so that (i) Vcs1 sharply rises and maintains the electric potential during the frame and (ii) Vcs2 sharply falls in sync with the rising of Vcs1 and maintains the electric potential during the frame. Alternatively, after each transistor turned off, it is possible to control a potential so that (i) Vcs1 sharply falls and maintains the electric potential during the frame and (ii) Vcs2 sharply rises in sync with the falling of Vcs1 and maintains the electric potential during the frame. The electric potential control illustrated in FIG. 35 is applicable to a structure (i.e. structures in FIG. 1, FIG. 4, and FIG. 5) in which each retentive capacity wiring is not shared by adjacent upper and lower pixels (adjacent pixels in a direction in which the data signal lines are provided). The electric potential control has a beneficial effect on a reduction in luminance unevenness because the effective value of the drain potential is less affected by the round waveform of Vcs1 and Vcs2.

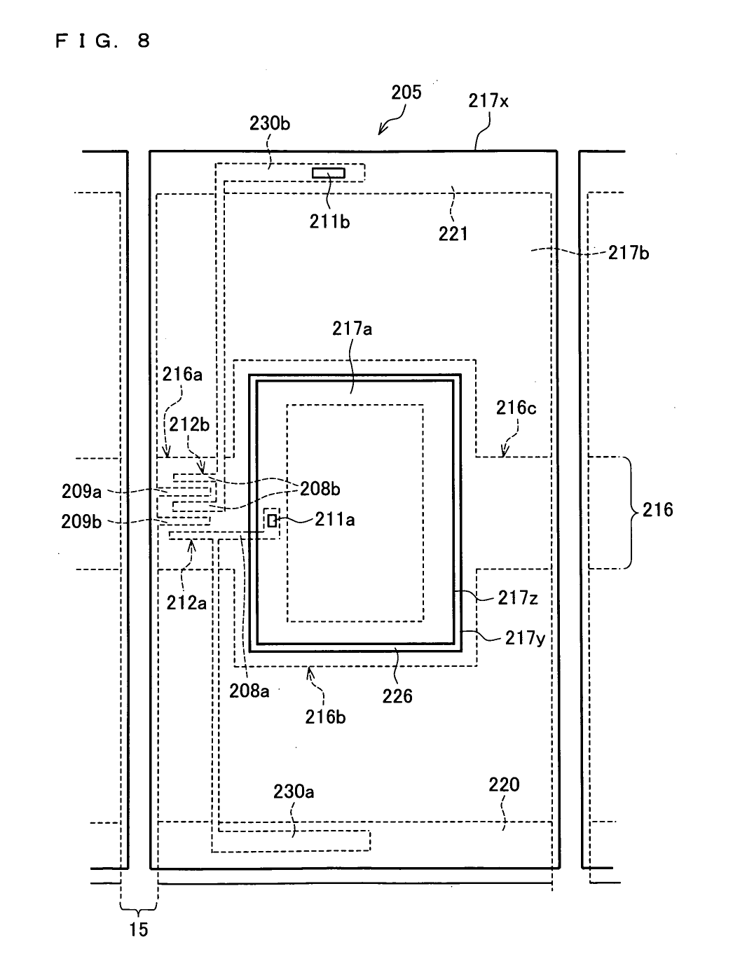

Further, as illustrated in FIG. 31, it is possible for Vcs1 to have a waveform in which “High” (or “Low”) is maintained at T3 coming right after Vg became “L” (each TFT 12a and 12b turned off) at T2, and for Vcs2 to have a waveform in which “Low” (or “High”) is maintained at T4 coming after one horizontal period is elapsed since T3 (one hour later). Namely, after each transistor turned off, it is possible to control an electric potential so that (i) Vcs1 sharply rises and maintains the electric potential during the frame and (ii) one horizontal period later from the rising of Vcs1, Vcs2 falls and maintains the electric potential during the frame. Alternatively, after each transistor turned off, it is possible to control an electric potential so that (i) Vcs1 falls and maintains the electric potential during the frame and (ii) one horizontal period later from the falling of Vcs1, Vcs2 rises and maintains the electric potential during the frame. This potential control illustrated in FIG. 31 is applicable not only to a structure in which each retentive capacity wiring is not shared by adjacent upper and lower pixels (i.e. a structure in FIG. 1 or other drawing), but also to a structure in which each retentive capacity wiring is shared by adjacent upper and lower pixels (i.e. a structure in FIG. 8). The applicability is one of advantages of the potential control illustrated in FIG. 31.

The following description deals with how each voltage waveform changes over time in the n-th frame in FIG. 31.

It is assumed that at time T0, Vcs1=(Vcom−Vad) and Vcs2=(Vcom+Vad) are satisfied. Note that Vcom is a voltage of the counter electrode.

At time T1, Vg is changed from VgL to VgH, and each TFT turns on. As a result, Vlc1 and Vlc2 rise to Vsp. Retentive capacitances Cs1, Cs2 and sub-pixel capacitances Csp1, Csp2 are charged, respectively.

At time T2, Vg is changed from VgH to VgL, and each TFT turns off. The retentive capacitances Cs1, Cs2 and the sub-pixel capacitances Csp1, Csp2 are electrically insulated from a data signal line, respectively. Right after this, a pull-in effect is caused by the influence of a parasitic capacity or other influence. As a result, the following equations are satisfied: Vlc1=(Vsp−Vd1), and Vlc2=(Vsp−Vd2).

At time T3, Vcs1 is changed from (Vcom−Vad) to (Vcom+Vad). At time T4 (one horizontal period later from T3), Vcs2 is changed from (Vcom+Vad) to (Vcom−Vad). As a result, the following equations are satisfied: Vlc1=(Vsp−Vd1+2×K×Vad), and Vlc2=(Vsp−Vd2−2×K×Vad). Note that K=Ccs/(Clc+Ccs) is satisfied, where Ccs is a capacitance value of each retentive capacitance (Cs1 and Cs2), and Clc is a capacitance value of each sub-pixel capacitance (Csp1 and Csp2).

According to this, effective voltages (V1 and V2) to be applied during the n-th frame to respective sub-pixel capacitance (first sub-pixel capacitance Csp1 and second sub-pixel capacitance Csp2) satisfy V1=(Vsp−Vd1+2×K×Vad−Vcom), and V2=(Vsp−Vd2−2×K×Vad−Vcom). This causes a high luminance area caused by the first sub-pixel capacitance Csp1 and a low luminance area caused by the second sub-pixel capacitance Csp2 to be formed within a single pixel.

With the arrangement, the round waveforms of Vcs1 and Vcs2 less affect the drain effective electric potential, thereby having a beneficial effect on a reduction in luminance unevenness.

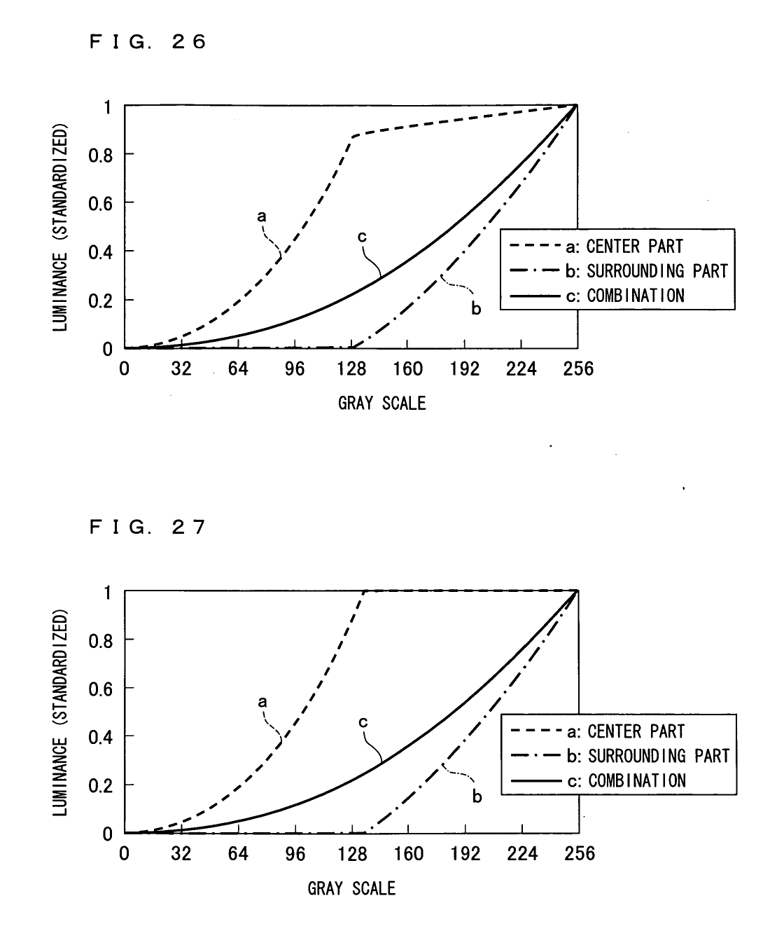

One example of the luminance distribution between the high luminance area and the low luminance area in the structure of the present embodiment is illustrated in FIG. 26. Note that 256 gray scale is used and an area ratio between the low luminance area and the high luminance area is 1:3. As shown in graph “a” and graph “b”, up to around 128 gray scale, luminance (luminance in a unit area) of the low luminance area remains 0 (lowest luminance), and luminance (luminance in a unit area) of the high luminance area increases from 0 to 0.85 (highest luminance is 1) in accordance with the increase in gray scale. From around 128 gray scale to 255 gray scale, as shown in graph “a” and graph “b”, luminance of the high luminance area gradually increases from 0.85 to 1.0. At the same time, the luminance of the low luminance area increases from 0 to 1.0. The total luminance (graph c=γ characteristic) of one pixel is calculated by (i) carrying out surface integral with respect to respective luminance of the low luminance area and the high luminance area, and then (ii) adding together the two surface integral.

Thus, according to a liquid crystal display device of the present embodiment, it is possible to provide in each pixel a low luminance area and a high luminance area surrounded by the low luminance area. The following description deals with how an image having a high spatial frequency can be clearly displayed by the structure in which each pixel has a high luminance area and a low luminance area surrounding the high luminance area.

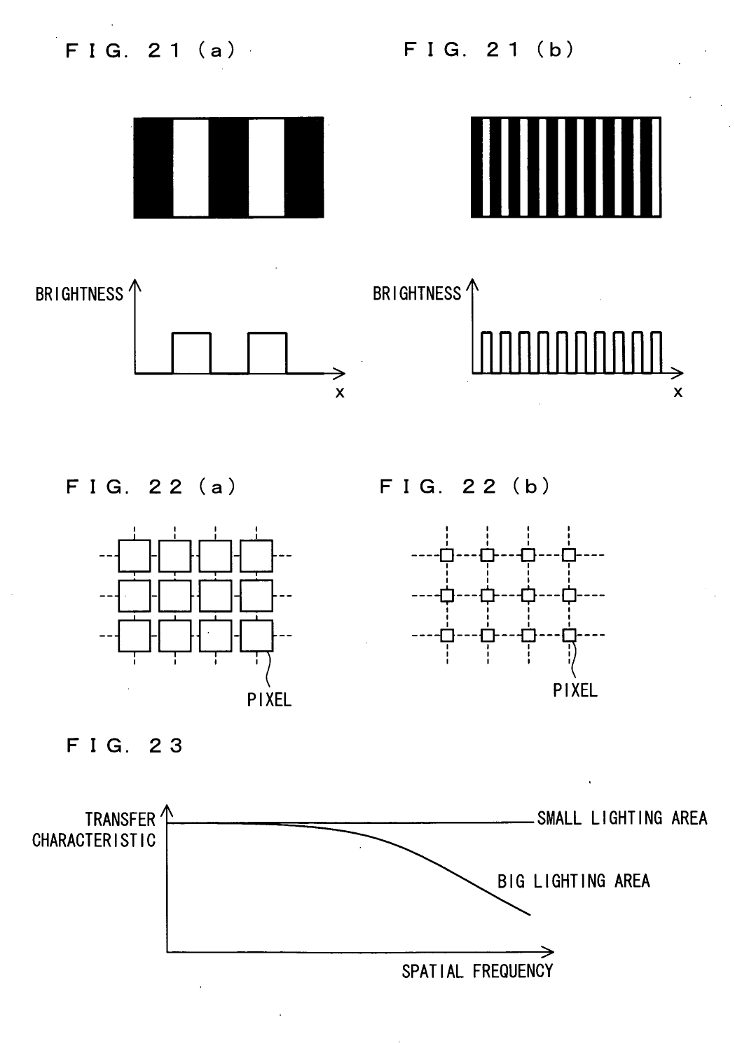

FIG. 21 (a) illustrates a schematic view of an image having a low spatial frequency, and FIG. 21 (b) illustrates a schematic view of an image having a high spatial frequency. Here, a transfer characteristic is defined by a ratio of an amplitude of a sign waveform supplied as an image signal to an amplitude of an output waveform supplied to a display. Also, FIG. 22 (a) is a schematic view illustrating a display device including a plurality of pixels having a large lighting area in matrix. FIG. 22(b) is a schematic view illustrating a display device including a plurality of pixels having a small lighting area in matrix. Further, FIG. 23 illustrates transfer characteristics of the display devices illustrated in FIGS. 22 (a) and in FIGS. 22 (b), respectively.

As is clear from FIG. 23, a display device having a small lighting area is superior to the display device having a large lighting area in transfer characteristic. It follows that the display device having a small lighting area can clearly display an image having a high spatial frequency as illustrated in FIG. 21 (b). The present invention is made by focusing attention on this principle. The display device of the present embodiment has pixels each of which has a pixel arrangement so that a low luminance area and a high luminance area surrounded by the low luminance can be provided. This causes the high luminance area to deal with the total luminance or substantially the total luminance of an entire pixel (the light irradiation is carried out from the center part of a pixel) so that most of gradation displays are carried out. This allows an image having a high spatial frequency to be clearly displayed because of a great improvement in transfer characteristic in a high spatial frequency area.

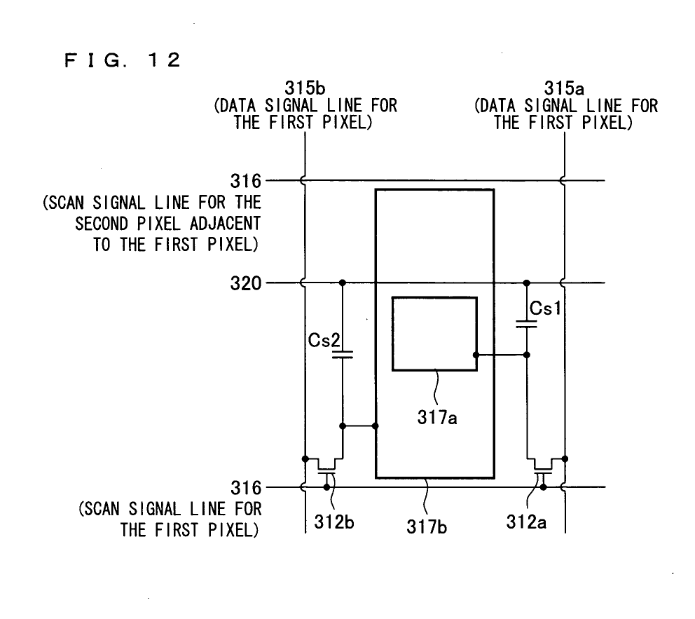

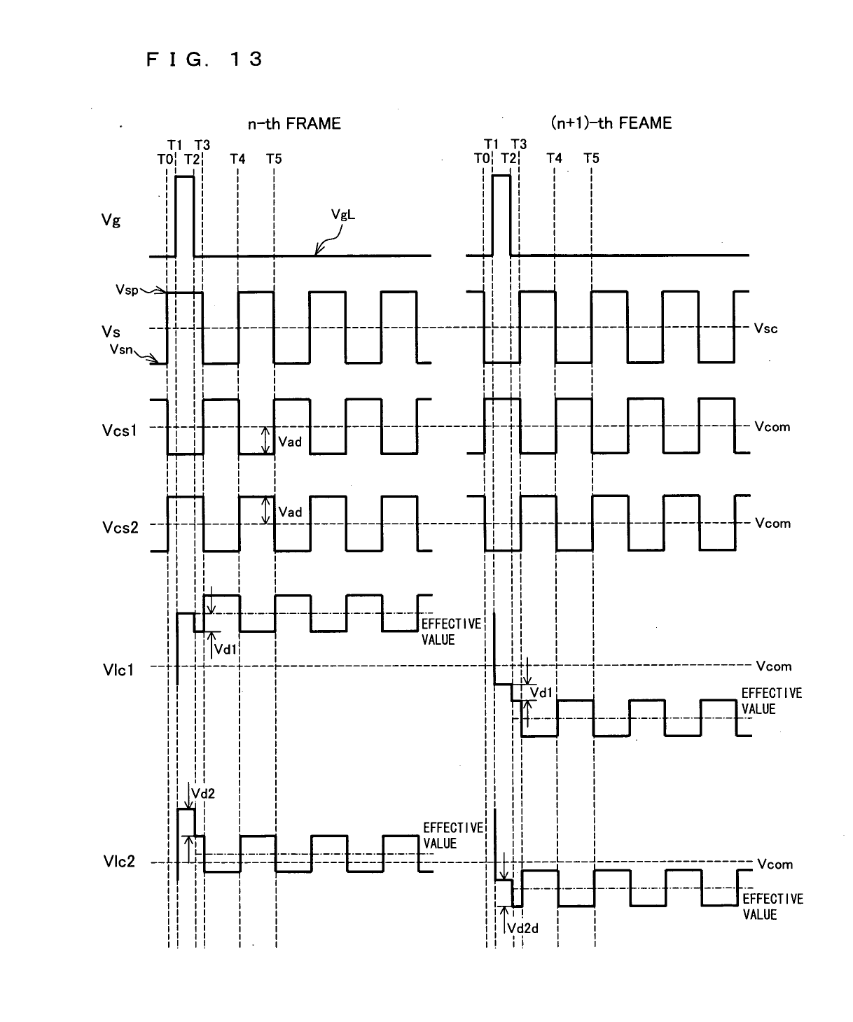

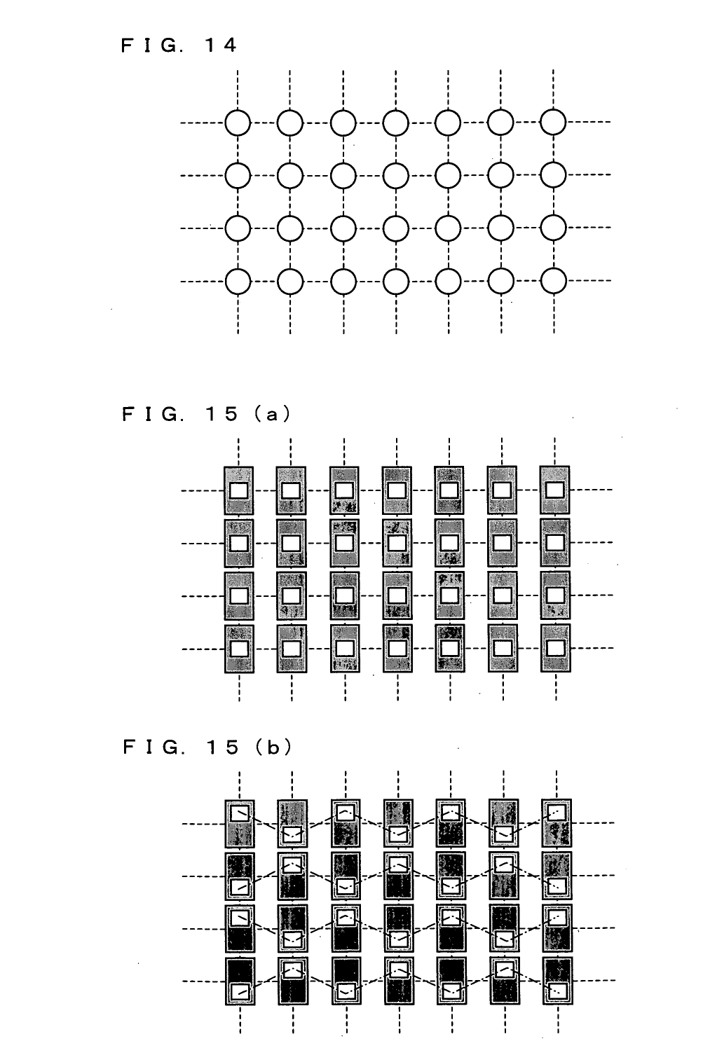

As illustrated in FIG. 15 (a), in an active matrix substrate of the present embodiment, a high luminance area is provided in a center part of each pixel, so as to be aligned orderly in line among pixels in a column direction (in an up-and-down direction in FIG. 15(a)). This allows an image as illustrated in scheme in FIG. 14 to be more clearly displayed, as compared with an arrangement (see FIG. 15 (b)) in which a high luminance area in each pixel is eccentric in a column direction.

In the active matrix substrate illustrated in FIG. 1, the first retentive capacity wiring 20 is wired in a frame shape so that the first retentive capacity wiring 20 and a gap area (gap area 26) between the first and second pixel electrodes overlap each other. Therefore, it is possible to avoid a decline in contrast due to leakage of light from the gap area 26, in a liquid crystal display device including the active matrix substrate.

Also, in the present embodiment, an active matrix substrate includes a light-shielding body (a first retentive capacity wiring 20). As such, no decline occurs in light-shielding effect due to the misalignment in combining of substrates like in cases where a light-shielding body is provided on a color filter substrate.

Further, according to the structure in FIG. 1, the first retentive capacity wiring 20 is wired in a frame shape in a single pixel area. It follows that the first retentive capacity wiring 20 has a plurality of wiring paths. Therefore, the first retentive capacity wiring 20 has a capability of well dealing with its breaking of wire.

An active matrix substrate may have a structure illustrated in FIG. 4. Namely, a pixel region 105 includes a first TFT (Thin Film Transistor) 112a, a second TFT 112b, a first sub-pixel electrode 117a, and a second sub-pixel electrode 117b.

The second sub-pixel electrode 117b has a rectangular shape which is hollowed out to have a hollow part. The second sub-pixel electrode 117b has (i) an outer rim 117x which has big rectangular shape and (ii) an inner rim (outer rim of the hollowed out) 117y which has a small rectangular shape. Inside the inner rim 117y, there is provided the first sub-pixel electrode 117a having a rectangular shape. Namely, an active matrix substrate of the present embodiment has a structure in which the first sub-pixel electrode 117a is surrounded by the second sub-pixel electrode 117b.

Between an outer rim 117z of the first sub-pixel electrode 117a and the inner rim 117y of the second sub-pixel electrode 117b, there is provided a gap area (126a through 126d). The gap area 126 has a frame shape including (i) the areas 126a and 126b, which are provided to extend in a row direction (in a transverse direction in FIG. 4) and (ii) the areas 126c and 126d which are provided to extend in a column direction (in an up-and-down direction in FIG. 4). A first retentive capacity wiring 121 is formed so that the first retentive capacity wiring 121, the area 126a, an adjacent area of the outer rim of the first sub-pixel electrode 117a, and an adjacent area of the inner rim of the second sub-pixel electrode 117b overlap each other. A second retentive capacity wiring 120 is formed so that the second retentive capacity wiring 120, the area 126b, an adjacent area of the outer rim of the first sub-pixel electrode 117a, and an adjacent area of the inner rim of the second sub-pixel electrode 117b overlap each other. Further, an upper electrode 130a is provided so that the upper electrode 130a, the first retentive capacity wiring 120 and the first sub-pixel electrode 117a overlap each other. The upper electrode 130a is connected to the first sub-pixel electrode 117a via a contact hole 111a. Also, an upper electrode 130b is provided so that the upper electrode 130b, the second retentive capacity wiring 121 and the second sub-pixel electrode 117b overlap each other.

The first TFT 112a and the second TFT 112b are provided in the vicinity of each intersection of a data signal line 15 and a scan signal line 16. A source electrode 109a of the first TFT 112a and a source electrode 109b of the second TFT 112b are connected to the data signal line 15. A drain electrode 108a of the first TFT 112a is connected to the upper electrode 130a via a drain lead-out wiring 107a. The drain lead-out wring 107a is wired so that the drain lead-out wring 107a, the area 126c extending in a column direction (in an up-and-down direction in FIG. 4), an adjacent area of the outer rim of the first sub-pixel electrode 117a, and an adjacent area of the inner rim of the second sub-pixel electrode 117b overlap each other. A drain electrode 108b of the second TFT 112b is connected to the second sub-pixel electrode 117b, via a drain lead-out wiring 107b and a contact hole 111b. Further, the drain lead wiring 107b is wired so that the drain lead wiring 107b, the area 126d extending in a column direction (in an up-and-down direction in FIG. 4), an adjacent area of the outer rim of the first sub-pixel electrode 117a, and an adjacent area of the inner rim of the second sub-pixel electrode 117b, and is connected to the upper electrode 130b.

As illustrated in FIG. 5, it is possible to connect the second sub-pixel electrode 117b and the upper electrode 130b via a contact hole 111c by eliminating a part of the drain lead wiring 107, in which part the drain lead wiring 107 and the area 126d do not overlap each other. This allows an increase in open area ratio.

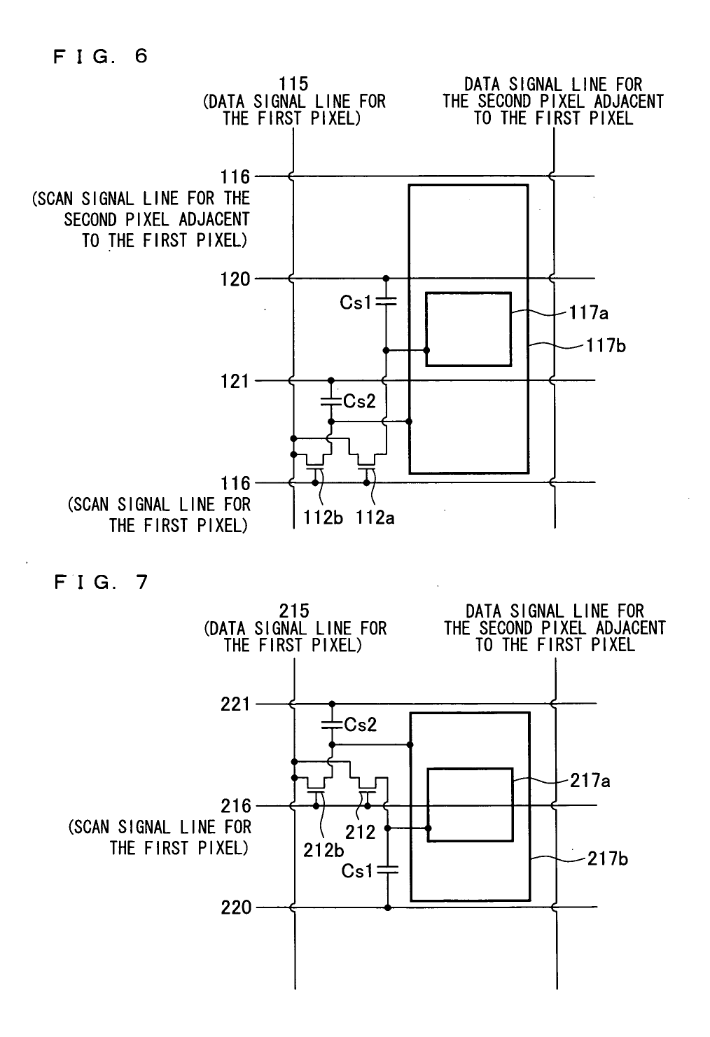

A circuit illustrated in FIG. 6 is realized by an active matrix substrate illustrated in FIG. 4 or in FIG. 5. Further, a driving method illustrated in FIG. 13 is applicable to a liquid crystal display device including an active matrix substrate in FIG. 4 or in FIG. 5.

It is possible to arrange an active matrix substrate of the present embodiment as illustrated in FIG. 8. Namely, a first TFT (Thin Film Transistor) 212a, a second TFT 212b, a first sub-pixel electrode 217a, and a second sub-pixel electrode 217b are formed in a pixel area 205.

The second sub-pixel electrode 217b has a rectangular shape which is hollowing out to have a hollow part. The second sub-pixel electrode 217b has (i) an outer rim 217x which has a big rectangular shape and (ii) an inner rim (outer rim of the hollow part) 217y has a small rectangular shape. Inside the inner rim 217y, there is provided the first sub-pixel electrode 217a. Namely, an active matrix substrate of the present embodiment has a structure in which the first sub-pixel electrode 217a is surrounded by the second sub-pixel electrode 217b.

In the arrangement, there is provided a scan signal line 216 in the center part of the pixel area 205. The scan signal line 216 in the pixel area 205 includes three sections, i.e., a left side section 216a as a gate electrode of the first TFT 212a and the second TFT 212b, a frame section 216b, and a right side section 216c. The first and second TFT 212a and 212b are provided in the vicinity of an intersection of a data signal line 15 and a scan signal line 216. A source electrode 209a of the first TFT 212a and a source electrode 209b of the second TFT 212b are connected to the data signal line 15.

There is provided a gap area 226 between an outer rim 217z of the first sub-pixel electrode 217a and the inner rim 217y of the second sub-pixel electrode 217b. A scan signal line 216 is wired so that the gap area 226, an adjacent area of the outer rim of the first sub-pixel electrode 217a, and an adjacent area of the inner rim of the second sub-pixel electrode 217b overlap each other. This allows the frame section 216b to be formed. A drain electrode 208a of the first TFT 212a is connected to the first sub-pixel electrode 217a via a drain lead-out wiring and a contact hole 211a.

Also, edges of the pixel area 205 (both edges in a column direction), first and second retentive capacity wiring 220 and 221 are provided in a row direction (in a transverse direction in FIG. 8). Also, an upper electrode 230a is provided so that the upper electrode 230a and the first retentive capacity wiring 220 overlap each other, and is connected to a drain electrode 208a. Further, an upper electrode 230b is provided so that the upper electrode 230b, the second retentive capacity wiring 221 and the second sub-pixel electrode 217b overlap each other. The upper electrode 230b is connected to the drain electrode 208b, and is connected to the second sub-pixel electrode 217b via a contact hole 211b.

According to the structure in FIG. 8, the first and the second retentive capacity wiring 220 and 221 can be shared between adjacent upper and lower pixels. This allows a reduction in the total number of the retentive capacity wiring. Also, the scan signal line 216 is wired in a frame shape in a single pixel area. It follows that the scan signal line 216 has a plurality of wiring paths. Therefore, the scan signal line 216 has a capability of well dealing with its breaking of wire.

A circuit illustrated in FIG. 7 is realized by an active matrix substrate illustrated in FIG. 8. Also, a driving method illustrated in FIG. 13 is applicable to a liquid crystal display device including an active matrix substrate in FIG. 8.

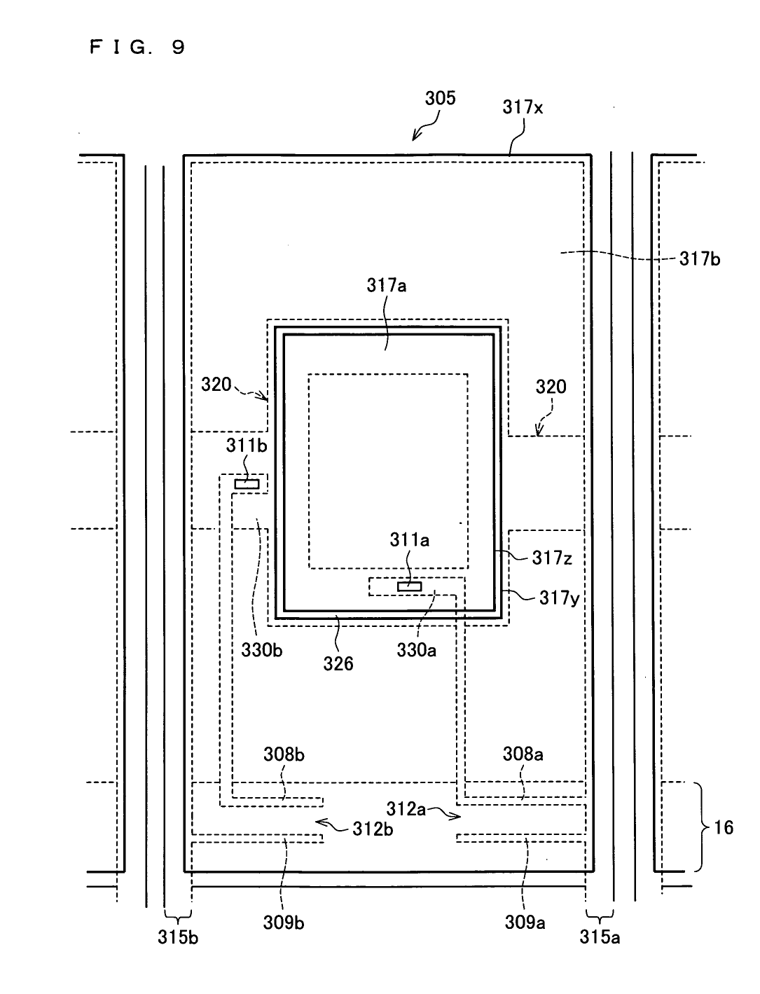

It is possible to arrange an active matrix substrate of the present embodiment as illustrated in FIG. 9. Namely, a first TFT (Thin Film Transistor) 312a, a second TFT 312b, a first sub-pixel electrode 317a, and a second sub-pixel electrode 317b are formed in a pixel area 305.

In the arrangement, two data signal lines 315a and 315b are provided for a single pixel area 305. The data signal lines 315a and 315b are provided in the vicinity of end parts on both sides of the pixel area 305 in a column direction (in an up-and-down direction in FIG. 9).

The second sub-pixel electrode 317b has a shape which is defined by hollowing out a rectangle part from the pixel region 305. The second sub-pixel electrode 317b has (i) an outer rim 317x which has a big rectangular shape and (ii) an inner rim (the rectangle part thus hollowed out) 317y which has a small rectangular shape. Inside the inner rim 317y, there is provided the first sub-pixel electrode 317a having a rectangular shape. Namely, an active matrix substrate of the present embodiment has a structure in which the first sub-pixel electrode 317a is surrounded by the second sub-pixel electrode 317b.

There is provided a gap area 326 between an outer rim 317z of the first sub-pixel electrode 317a and an inner rim 317y (the rectangle part thus hollowed out) of the second sub-pixel electrode 317b. A retentive capacity wiring 320 is wired in a frame shape so that the gap area 326, an adjacent area of the outer rim of the first sub-pixel electrode 317a, and an adjacent area of the inner rim of the second sub-pixel electrode 317b overlap each other. Further, an upper electrode 330a is provided so that the retentive capacity wiring 320 and the first sub-pixel electrode 317a overlap each other. This upper electrode 330a is connected to the first sub-pixel electrode 317a via a contact hole 311a. Also, an upper electrode 330b is provided so that the retentive capacity wiring 320 and the second sub-pixel electrode 317b overlap each other. The upper electrode 330b is connected to the second sub-pixel electrode 317b via a contact hole 311b.

The first TFT 312a is provided in the vicinity of an intersection of a scan signal line and the data signal line 315a. A source electrode 309a of the first TFT 312a is connected to the data signal line 315a, and a drain electrode 308a of the first TFT 312a is connected to the upper electrode 330a, via a drain lead-out wiring. Also, the second TFT 312b is provided in the vicinity of an intersection of a scan signal line and the data signal line 315b. A source electrode 309b of the second TFT 312b is connected to the data signal line 315b, and a drain electrode 308b of the second TFT 312b is connected to the upper electrode 330b, via a drain lead-out wiring.

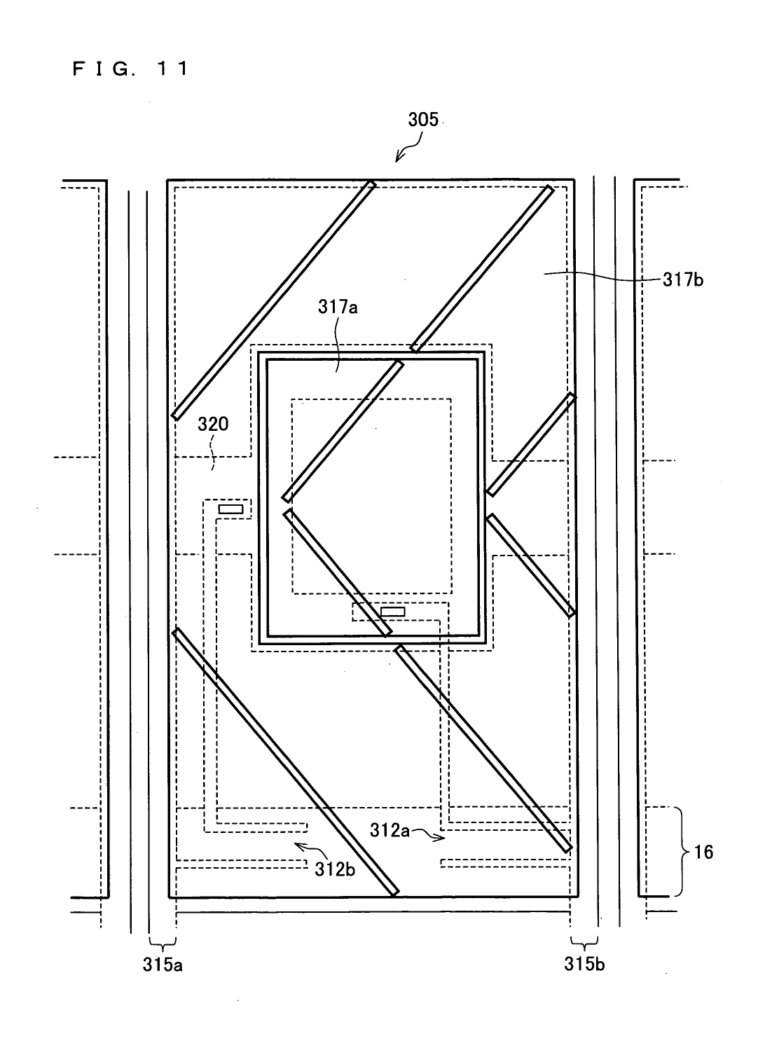

A circuit illustrated in FIG. 12 is realized by an active matrix substrate illustrated in FIG. 9. Note that the two data signal lines 315a and 315b for each pixel are driven independently. For example, a signal electric potential is applied to each of the data signal lines separately from a source driver controlled by a liquid crystal controller.

FIG. 27 illustrates one example of the luminance distribution of a high luminance area and a low luminance area (light intensity per unit area) in an arrangement of the present embodiment. Note that 256 gray scale is used, and an area ratio of a low luminance area to a high luminance area is 3:1. As shown in graph “a” and graph “b”, up to around 128 gray scale, luminance of the low luminance area remains 0 (normalized minimum luminance), and luminance from 0 to 1.0 (normalized maximum luminance) increases in accordance with an increase in gray scale. From around 128 gray scale to 255 gray scale, as shown in the graph “a” and “b”, luminance of the high luminance area remains 1.0. In accordance with an increase in gray scale, luminance of the low luminance area increases from 0 to 1.0. The total luminance (graph c=γ characteristic) of one pixel is calculated by (i) carrying out surface integral with respect to respective luminance of the low luminance area and the high luminance area, and then (ii) adding together the two surface integral.

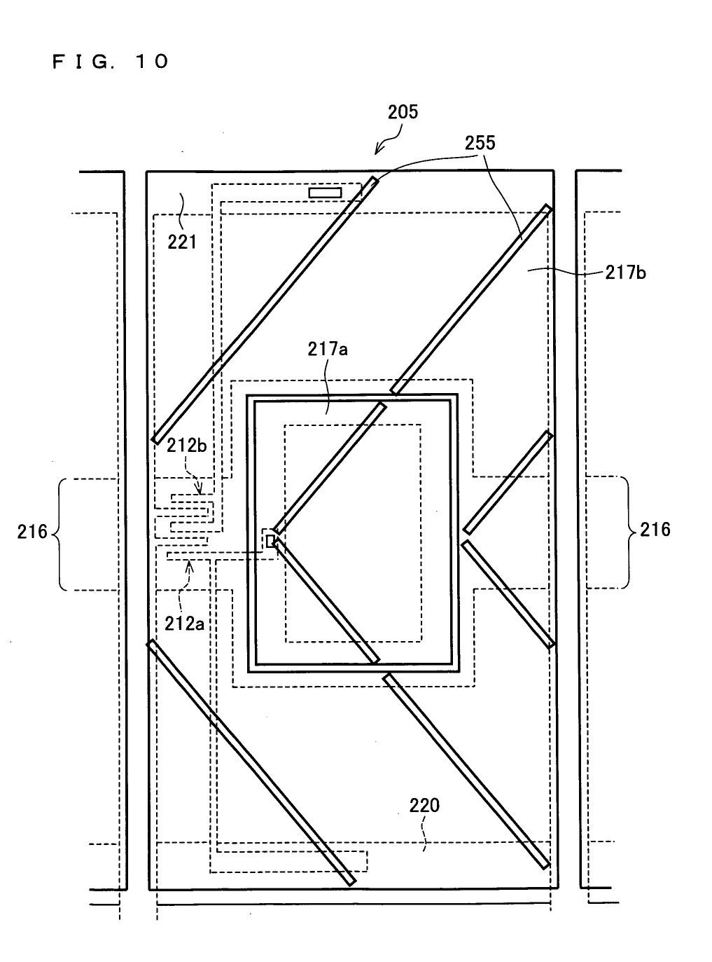

It is also possible, as illustrated in FIG. 10, to arrange an active matrix substrate in FIG. 8 so that it has an MVA (Multi-domain Vertical Alignment) structure. Specifically, a slit 255 (slit for an alignment control of liquid crystal molecules), having a V-shaped (a shape obtained by rotating V by 90 degrees), for controlling an alignment of liquid crystal molecules is provided to a first sub-pixel electrode 217a and a second sub-pixel electrode 217b. Note that in the MVA structure, a fringe filed is utilized. Such a fringe filed is generated by (i) a slit (electrode removal pattern) provided at a pixel electrode of an active matrix substrate and (ii) a projection (rib), provided to a counter electrode of a counter substrate, for controlling an alignment of liquid crystal molecules. The fringe field causes liquid crystal molecules to be dispersed in a plurality of directions, thereby resulting in that a wide view angle is realized. Similarly, it is possible to arrange an active matrix substrate in FIG. 9 so that it has an MVA structure (see FIG. 11).

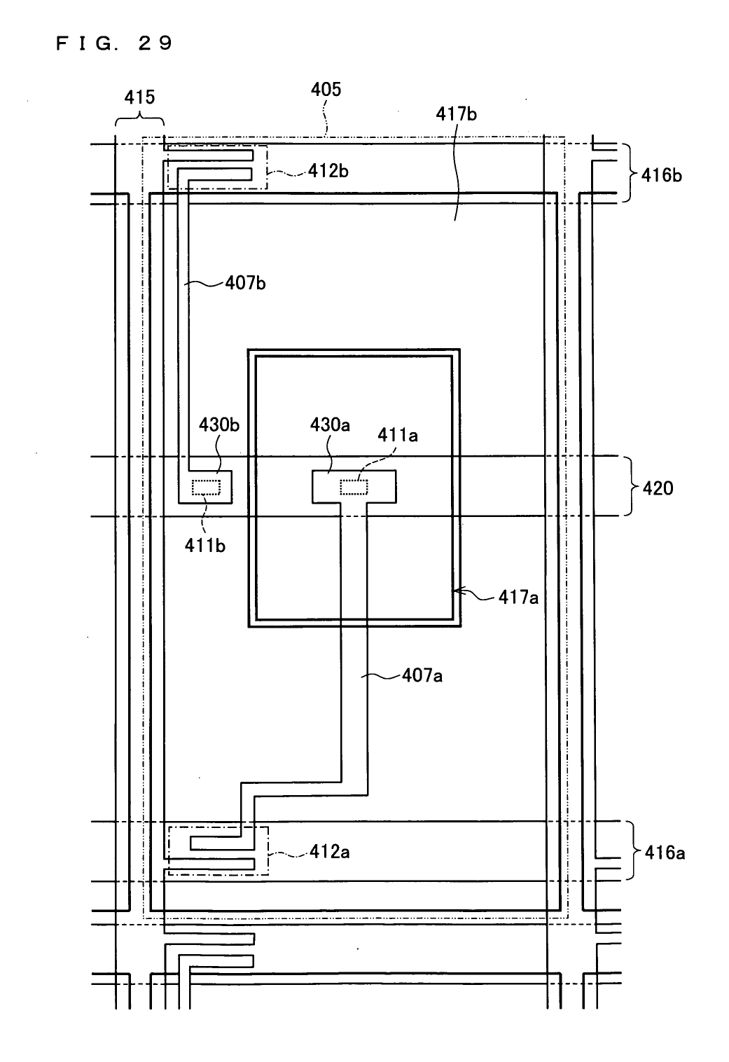

It is possible to arrange an active matrix substrate of the present embodiment as illustrated in FIG. 29. The active matrix substrate illustrated in FIG. 29 includes (i) a pixel region 405 in matrix, (ii) first and second scan signal lines 416a and 416b which are provided at upper and lower end parts of the pixel region so as to extend in a row direction (in a transverse direction in FIG. 29), (iii) a data signal line 415 provided to extend in a column direction (in an up-and-down direction in FIG. 29), and (iv) a pixel capacity wiring 420.

The pixel region 405 includes a first TFT 412a, a second TFT 412b, a first sub-pixel electrode 417a, and a second sub-pixel electrode 417b. The second sub-pixel electrode 417b has a shape which is defined by hollowing out a rectangle part from the pixel region 405. The second sub-pixel electrode 417b has (i) an outer rim 417x which has a big rectangular shape and (ii) an inner rim (the rectangle part thus hollowed out) 417y which has a small rectangular shape. Inside the inner rim 417y, there is provided the first sub-pixel electrode 417a having a rectangular shape. Namely, an active matrix substrate of the present embodiment has a structure in which the first sub-pixel electrode 417a is surrounded by the second sub-pixel electrode 417b.

The retentive capacity wiring 420 is wired across a center part of a pixel region. An upper electrode 430b is provided so that the upper electrode 430b, the retentive capacity wiring 420 and the second sub-pixel electrode 417b overlap each other. An upper electrode 430a is provided so that the upper electrode 430a, the retentive capacity wiring 420 and the first sub-pixel electrode 417a overlap each other.

The first TFT 412a is provided in the vicinity of an intersection of a data signal line 15 and a first scan signal line 16a, and the first scan signal line 16a serves as a gate electrode of the first TFT 412a. The second TFT 412b is provided in the vicinity of an intersection of a data signal line 15 and a second scan signal line 16b, and the second scan signal line 16b serves as a gate electrode of the second TFT 412b. A source electrode of the first TFT 412a and a source electrode of the second TFT 412b are connected to the data signal line 415.

Further, a drain electrode of the first TFT 412a is connected to the upper electrode 430a, via a drain lead-out wiring 407a. The upper electrode 430a is connected to the first sub-pixel electrode 417a, via a contact hole 411a. Also, a drain electrode of the second TFT 412b is connected to the upper electrode 430b via a drain lead-out wiring 407b, and the upper electrode 430b is connected to the second sub-pixel electrode 417b, via a contact hole 411b.

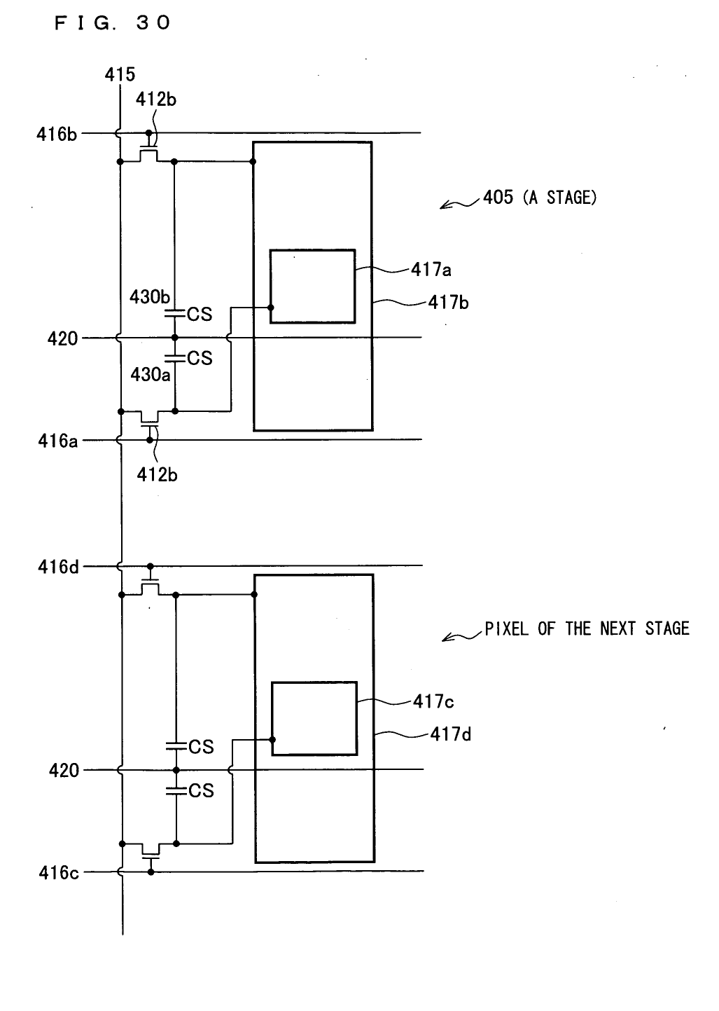

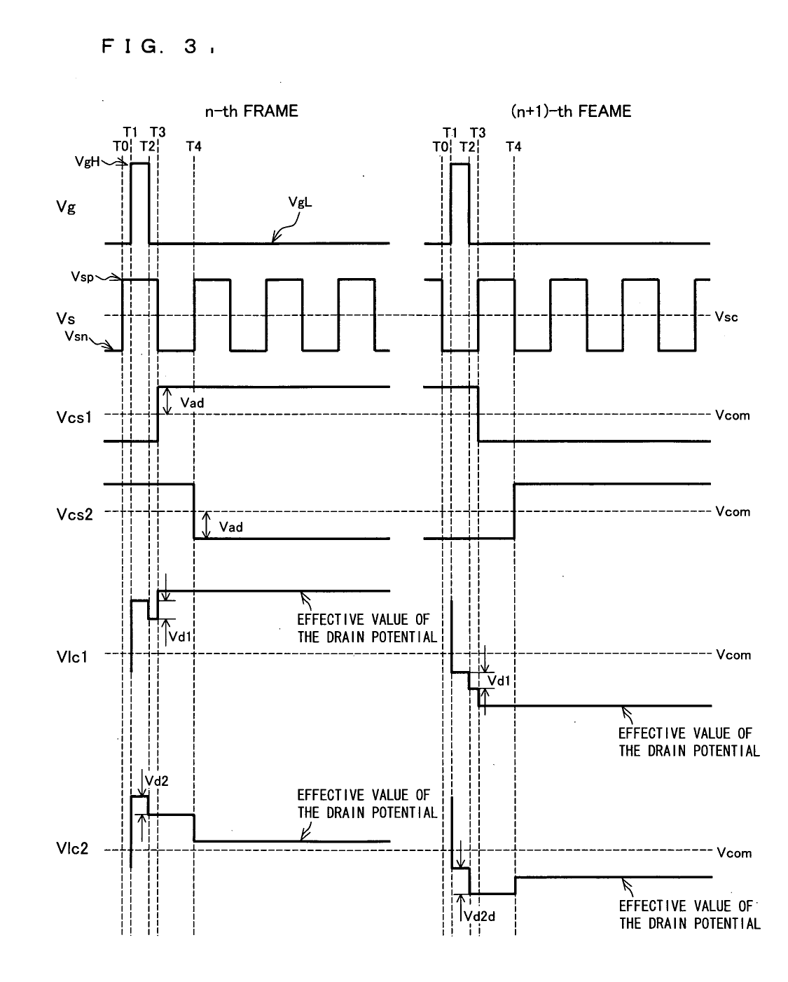

A circuit illustrated in FIG. 30 is realized by the arrangement. Namely, the first sub-pixel electrode 417a is connected to a data signal line 415 via the first TFT 412a, and the second sub-pixel electrode 417b is connected to the data signal line 415 via the second TFT 412b. A gate electrode of the first TFT 412a is connected to the first scan signal line 416a, and a gate electrode of the second TFT 412b is connected to the scan signal line 416b. A retentive capacitance CS is generated between the upper electrode 430a, which is connected to the first sub-pixel electrode 417a and the retentive capacity wiring 420. Similarly, a retentive capacitance CS is generated between the upper electrode 430b, which is connected to the second sub-pixel electrode 417b and the retentive capacity wiring 420. Note that scan signals (pulse signal) each having different timing are applied to first and second scan signal lines 21, respectively. Note that reference numerals 416c and 416d are supposed to be first and second scan signal lines for the next stage and that reference numerals 417c and 417d are supposed to be first and second TFTs for the next stage.

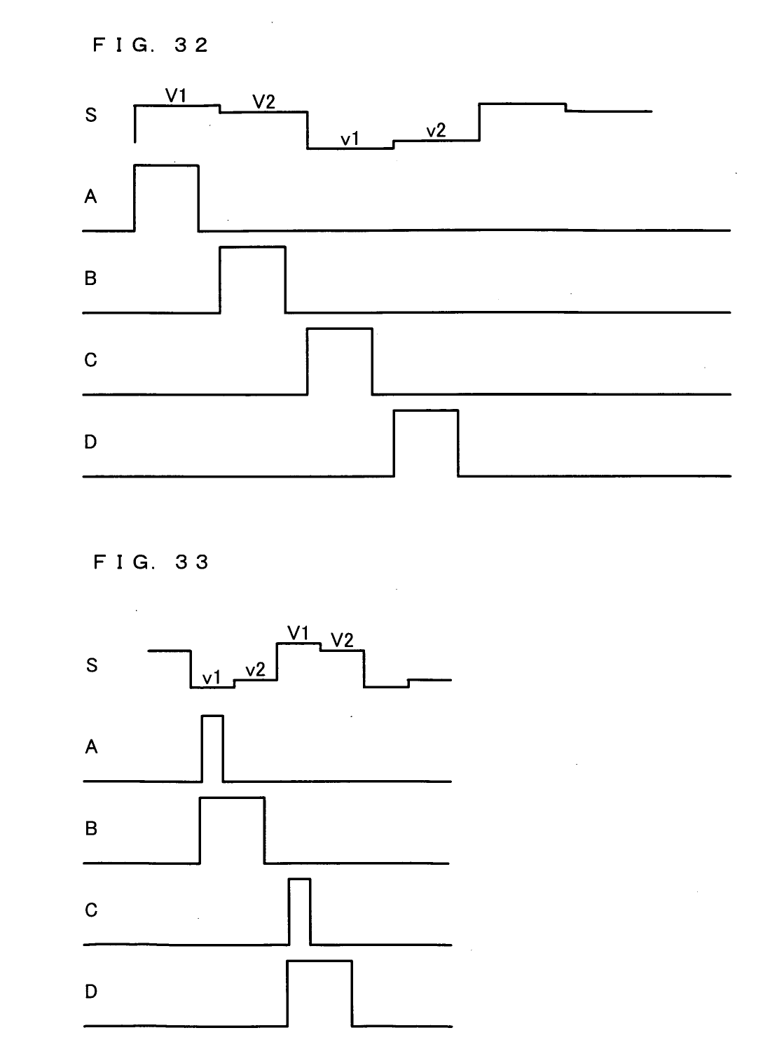

FIG. 32 shows each signal waveform obtained in cases where the circuit in FIG. 30 is driven based on the dot inversion driving. In FIG. 32, S refers to a waveform of an electric potential signal applied to the data signal line 415, and A through D refer to waveforms of pulse signals applied to the scan signal lines 416a through 416d, respectively.

As shown in FIG. 32, during one horizontal period, on-pulse signals (scan signals) are applied to the first scan signal line 416a and the second scan signal line 416b, respectively, in this order. In response to each of the on-pulse signals, signal electric potentials V1 and V2 (each having a positive polarity) are applied to the data signal line 415. Note that the on-pulse signals applied to the first and second scan signal lines do not temporally (in terms of time) overlap each other. This causes (i) V1 to be written in the first sub-pixel electrode 417a, via the first TFT 412a and (ii) V2 to be written in the second sub-pixel electrode 417b, via the second TFT 412b. Further, in the following horizontal period, on-pulse signals are applied to a first scan signal line 416c and a second scan signal line 416d in the next stage, respectively, in this order. In response to each of the on-pulse signals, signal electric potentials v1 and v2 (each having a negative polarity) are applied to the data signal line 415. This causes (i) v1 to be written in the first sub-pixel electrode 417c of the next stage, and (ii) v2 to be written in the second sub-pixel electrode 417d in the next stage.

Alternatively, in cases where the circuit in FIG. 30 is driven based on the dot inversion driving, signal waveforms may become as signal waveforms in FIG. 33. In FIG. 33, S refers to a waveform of an electric potential signal applied to the data signal line 415, and A through D refer to waveforms of pulse signals applied to the scan signal lines 416a through 416d, respectively.

Namely, during a horizontal period, on-pulse signals (scan signals) are applied to the first scan signal line 416a and the second scan signal line 416b, respectively. In response to the on-pulse signals, signal electric potentials v1 and v2 (each having a negative polarity) are applied to the data signal line 415. At this time, the on-pulse signals applied to the first and second scan signal lines, respectively, are set so that (i) they partially overlap each other for a certain period of time and (ii) become in their off-states at different timing, respectively. For example, these two on-pulse signals are set so that (i) they simultaneously become in their on-states and (ii) the on-pulse signal applied to the first scan signal line 416a becomes in its off-state earlier than that applied to the second scan signal line 416b. For example, these two on-pulse signals become in their off-states so as to differ in phase by ½H (a half of one horizontal period). Further, an electric potential applied to the data signal line 415 is set so that (1) it is changed into v1 either (i) in sync with the timing at which the two on-pulse signals become in their on-states or (ii) before the timing and then (2) the v1 is changed into v2 either (a) in sync with the timing at which one of the two on-pulse signals (the on-pulse applied to the first scan signal line 416a) becomes in its off-state earlier than the other or (b) after the timing. This causes (i) v1 to be written in the first sub-pixel electrode 417a and (ii) v2 to be rewritten in the second sub-pixel electrode 417b after v1 is written in the second sub-pixel electrode 417b. Further, in the following horizontal period, the on-pulse signals are applied to the first and second scan signal lines 416c and 416d of the next stage at the above timing. In response to the respective on-pulse signals, signal electric potentials V1 and V2 (each having a positive polarity) are applied to the data signal line 415. Namely, V1 is changed into V2 either (a) in sync with the timing at which the on-pulse signal applied to the first scan signal line 416a becomes in its off-state earlier than the other or (b) after the timing. This causes (i) V1 to be written in the first sub-pixel electrode 417c of the next stage and (ii) V2 to be rewritten in the second sub-pixel electrode 417d of the next stage after the V1 is written in the second sub-pixel electrode 417d.

This allows the second sub-pixel electrode 417b, which is connected to the second TFT 412b controlled by the second scan signal line 416b, to be charged in a good condition because, after the electric potential v1 (having a same polarity as a potential to be written) is once applied to the second sub-pixel electrode 417b, the electric potential v2 (an electric potential to be rewritten) is applied to the second sub-pixel electrode 417b. This is especially effective (i) in cases where the polarity of the signal potential applied to the data signal line 415 is inverted for every horizontal period (namely, in cases where a distortion of the signal potential is large), such as the dot inversion driving and the H line inversion driving or (ii) in cases where the second sub-pixel electrode 417b has a large area (namely, in cases where it takes long for charging to be carried out). A driving method shown in FIG. 33 can further achieve an effect that suppresses a driving frequency of the scan signal because the on-pulse signal has a longer cycle in the method of FIG. 33 than in the method of FIG. 32.

A liquid crystal display panel is prepared by (1) combining an active matrix substrate obtained by the present embodiment and a color filter substrate including (i) a plurality of colored layers for Red, Green, and Blue colors which are provided in matrix so as to correspond to a respective one of pixels of the active matrix substrate and (ii) a black matrix for light-shielding which is provided so as to be alternately provided in the colored layers, and (2) injecting and sealing a liquid crystal.

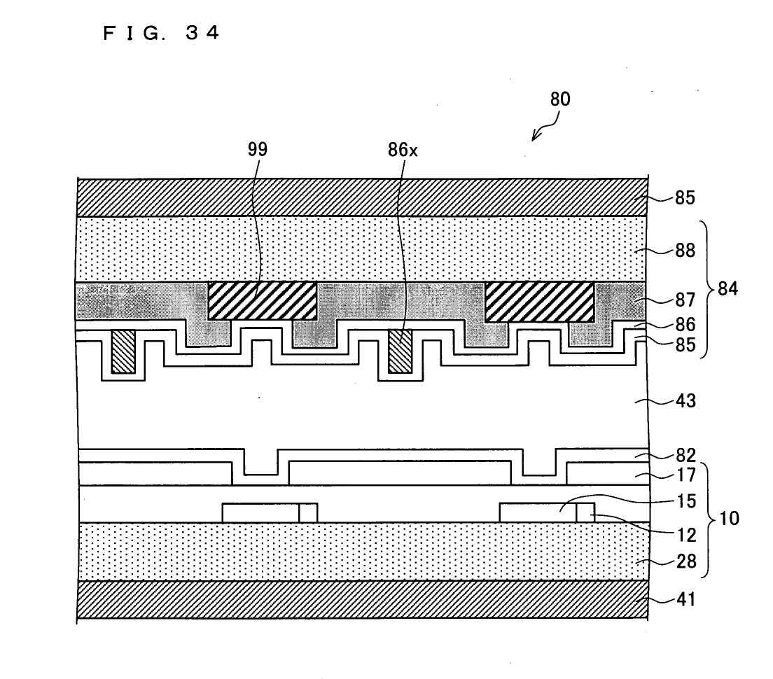

A liquid crystal display panel thus prepared is illustrated in FIG. 34. As illustrated in FIG. 34, a liquid crystal panel 80 includes a polarization plate 41, an active matrix substrate 10 having a glass substrate 28, an alignment film 82, a liquid crystal layer 43, a color filter substrate 84, and a polarization plate 85 in this order from the side of a back light source. The color filter substrate 84 includes an alignment film 85, a common (counter) electrode 86, a colored layer 87 (including a black matrix 99), and a glass substrate 88 in this order from the side of the liquid crystal layer 43. The common (counter) electrode 86 includes a projection (rib) 86x for controlling the alignment of liquid crystal molecules. The projection (rib) 86x is made of material such as photosensitive resin. For example, the rib 86x has a plane shape such as (a shape obtained when viewed in a direction perpendicular to the surface of the substrate) a strip-shaped (V-shaped (a shape obtained by rotating V by 90 degrees)) inflected in zigzags having a certain cycle. A liquid crystal display of the present invention is prepared by connecting a circuit such as a driver (LSI for driving liquid crystal), and providing a polarization plate and a back light.

The following description deals with a television receiver to which a liquid crystal display device of the present embodiment is applied.

FIG. 16 is a circuit block illustrating a liquid crystal display device 601 for a television receiver. The liquid crystal display device 601 includes, as illustrated in FIG. 16, a Y/C separating circuit 500, a video chroma circuit 501, an A/D converter 502, a liquid crystal controller 503, a liquid crystal panel 504, a back light driving circuit 505, a back light 506, a microcomputer 507, and a gray scale circuit 508. In the liquid crystal display device 601 having the above structure, an input image signal (television signal) is supplied to the Y/C separating circuit 500 so as to be separated into a luminance signal and a color signal. The luminance signal and the color signal are converted into analog R, G, and B signals (three primary colors) by the video chroma circuit 501. Further, the analogue RGB signals are converted into digital RGB signals by the A/D converter 502, and are then supplied to the liquid crystal controller 503. The liquid crystal panel 504 receives the RGB signals from the liquid crystal controller 503 at certain timing, and receives each of the R, G, and B gray scale voltages from the gray scale circuit 508. The liquid crystal panel 504 displays an image in response to the liquid crystal controller 503 and the gray scale circuit 508. Including this kind of processes, the entire system is controlled by the microcomputer 507. It is possible for the liquid crystal display device 601 to display a variety of image signals such as an image signal from a television broadcast, an image signal obtained by a camera, and an image signal supplied via the internet.

Note that an active matrix substrate is applicable to a liquid crystal display device in which a field sequential method is adopted. One pixel in the filed sequential method illustrated in FIG. 17(a) corresponds to three primary colors (R, G, and B) in a color filter method illustrated in FIG. 17 (b), and displays three primary colors (R, G, and B) consecutively (two or more colors will never be displayed at a time). In the field sequential method liquid crystal display device, for example a drive illustrated in FIG. 8 is carried out. Namely, one frame is divided into three sub-frames, i.e., first through third sub-frames. In the first sub-frame, an R image signal is supplied to the liquid crystal panel, and back light is lighted in Red (R) color. As a result, the R image signal is displayed in the liquid crystal panel. Similarly, in the second sub-frame, a G image signal is supplied to the liquid crystal panel, and the back light is lighted in Green (G) color. As a result, the G image signal is displayed in the liquid crystal panel. In the third sub-frame, a B image signal is supplied to the liquid crystal panel, and the back light is lighted in Blue (B) color. As a result, the B image signal is displayed in the liquid crystal.

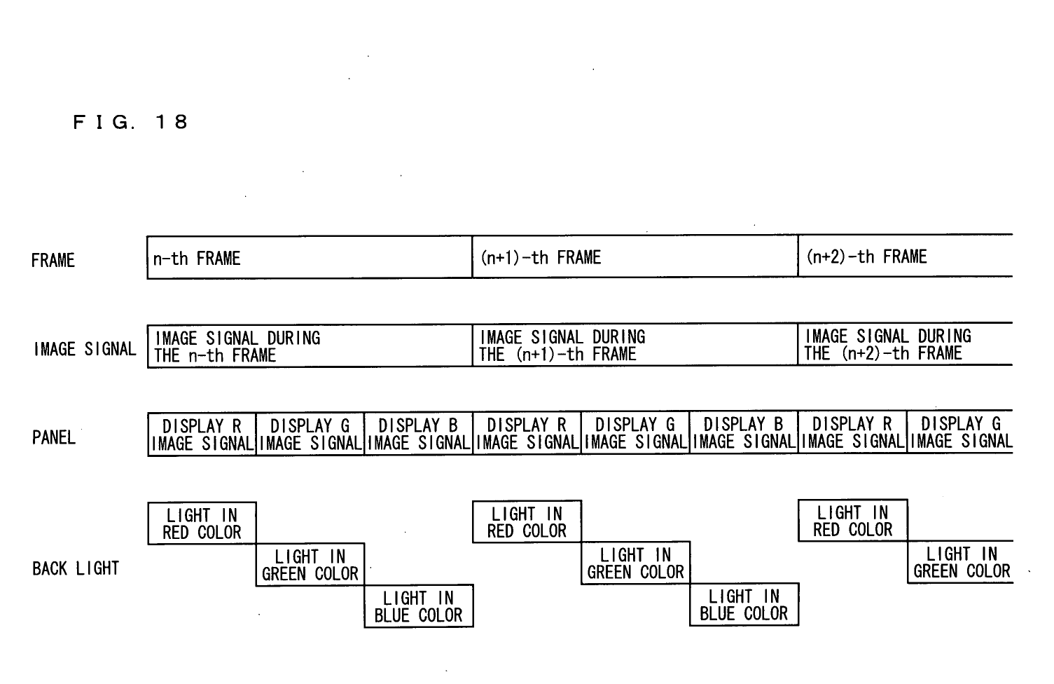

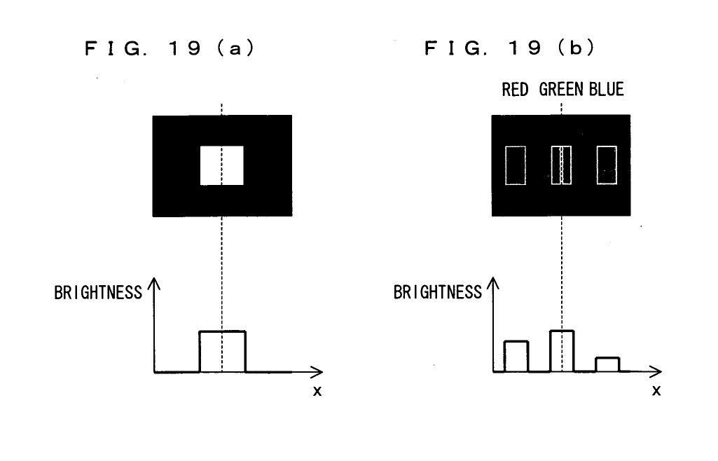

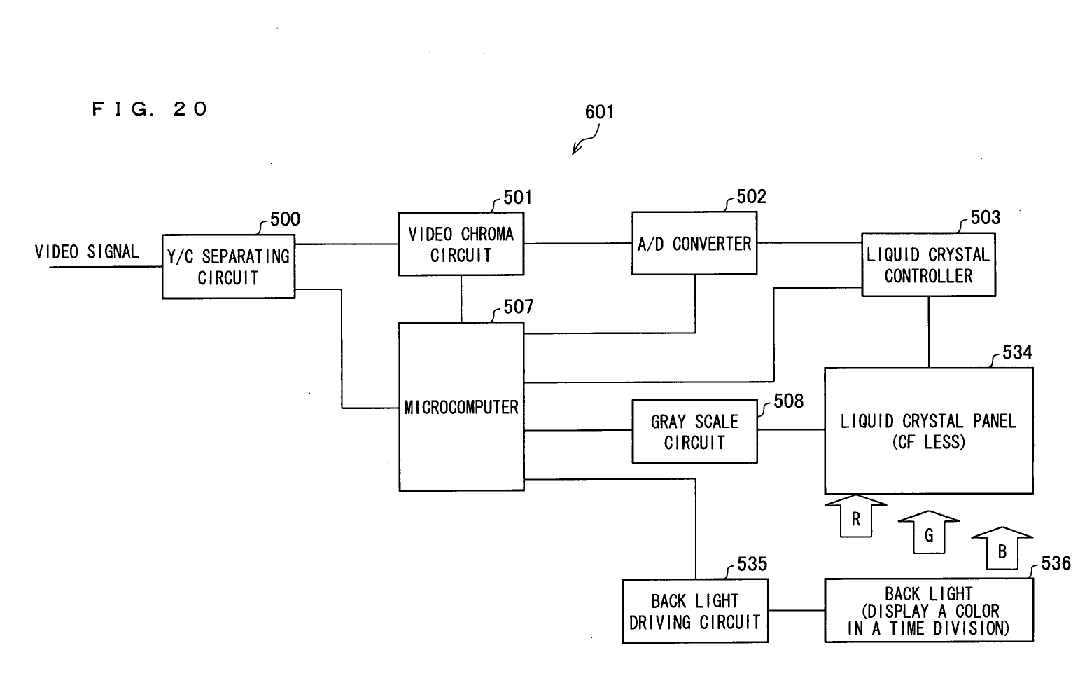

The filed sequential method has an advantage that positions of color information for respective colors are identical to each other (respective colors are displayed in the middle portion of a pixel as illustrated in FIG. 19 (a)). This is unlike the structure of using a color filter (positions of color information deviates from each other depending on their colors as illustrated in FIG. 19 (b)). A circuit block of a liquid crystal display device in which the field sequential method is adopted is illustrated in FIG. 20.

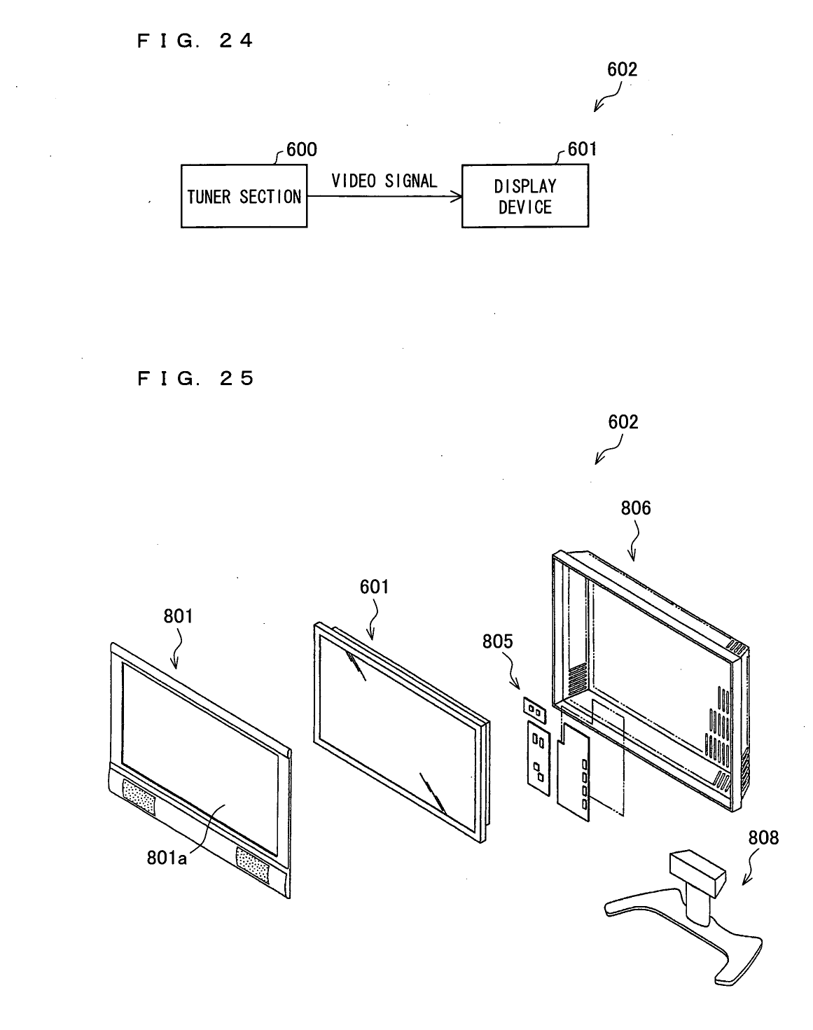

As illustrated in FIG. 24, it is possible for the liquid crystal display device 601 to display a video (an image) based on a video signal supplied from a tuner section 600, by connecting the tuner section 600 that receives television broadcast and outputs the video signal. In this case, the liquid crystal display device 601 and the tuner section 600 constitute a television receiver 602.

The television receiver 602 in which the liquid crystal display device 601 is used is realized by, for example the following arrangement. Specifically, as illustrated in FIG. 25, the liquid crystal display device 601 is sandwiched between a first case 801 and a second case 806 so as to be encased by the first case 801 and the second case 806. The first case 801 has an opening 801a which causes an image displayed by the liquid crystal display device 601 to pass through. The second case 806 which covers the back surface side of the liquid crystal display 601, includes (i) a control circuit 805 for controlling the liquid crystal display device and (ii) a supporting member 808 at its bottom part.

Note that the present invention is not limited to a liquid crystal display device. For example, it is possible to realize an organic EL display device by the following arrangement. Specifically, an organic EL panel is prepared by providing an organic EL layer between a color filter substrate and an active matrix substrate of the present invention which is provided so as to face the color filter substrate. Thereafter, a driver and the like are connected to an external lead-out terminal of the organic EL panel, thereby preparing. The present invention is not limited to a liquid crystal display device and an organic EL display device, provided that a display device is constituted by an active matrix substrate.

### INDUSTRIAL APPLICABILITY

An active matrix substrate of the present invention is suitable for a device such as a liquid crystal television.

1. A display device comprising:
a plurality of pixels, wherein:
a first luminance area and a second luminance area which surrounds the first luminance area and has a luminance lower than that of the first luminance area are capable of being formed in each of the pixels.

2. The display device according to claim 1, wherein each of the pixels further includes:
a first switching element;
a second switching element;
a first sub-pixel electrode connected to the first switching element; and
a second sub-pixel electrode which surrounds the first sub-pixel electrode and is connected to the second switching element.

3. The display device according to claim 1, wherein:
said first luminance area and said second luminance area have shapes which have a same gravity center.

4. The display device according to claim 1, wherein:
a lowest luminance area is provided between said first luminance area and said second luminance area.

5. The display device according to claim 1, wherein:
said first luminance area and said second luminance area are adjacent to each other.

6. The display device according to claim 4, further comprising:
an active matrix substrate; and
a color filter substrate,
said lowest luminance area is formed at least one of a black matrix in the color filter substrate and a light-shielding body in the active matrix substrate.

7. The display device according to claim 2, wherein:
said first switching element and said second switching element are connected to a same data signal line.

8. The display device according to claim 7, wherein:
said first switching element and said second switching element are connected to a same scan signal line.

9. The display device according to claim 8, further comprising:
a first retentive capacity wiring, said first sub-pixel electrode and the first retentive capacity wiring defining capacitance; and
a second retentive capacity wiring, said second sub-pixel electrode and the second retentive capacity wiring defining capacitance,
electric potentials of the first retentive capacity wiring and the second retentive capacity wiring being independently controlled.

10. The display device according to claim 9, wherein:
said first retentive capacity wiring and said second retentive capacity wiring are controlled to have waveforms whose phase shift is 180°.

11. The display device according to claim 9, wherein:
(i) the first retentive capacity wiring is controlled to have an electric potential which increases after each of the switching elements turns off and is then maintained until each of the switching elements turns off in a following frame; and
the second retentive capacity wiring is controlled to have an electric potential which decreases after each of the switching elements turns off and is then maintained until each of the switching elements turns off in the following frame, or
(ii) the first retentive capacity wiring is controlled to have an electric potential which decreases after the each of the switching elements turns off and is then maintained until each of the switching elements turns off in a following frame; and
the second retentive capacity wiring is controlled to have an electric potential which increases after each of the switching elements turns off and is then maintained until each of the switching elements turns off in the following frame.

12. The display device according to claim 2, wherein:
said first switching element and said second switching element are connected to first signal line and second scan signal line, respectively.

13. The display device according to claim 12, wherein:
an on-pulse signal applied to said first scan signal line and an on-pulse signal applied to said second scan signal line do not temporally overlap.

14. The display device according to claim 12, wherein:
an on-pulse signal applied to said first scan signal line and an on-pulse signal applied to said second scan signal line overlap for a certain period of time but become in their off-states at different timing, respectively.

15. The display device according to claim 14, wherein:
the on-pulse signal applied to the first scan signal line and the on-pulse signal applied to the second scan signal line simultaneously become in their on-states but the on-pulse signal applied to the first scan signal line becomes in its off-state earlier than the on-pulse signal applied to the second scan signal line.

16. The display device according to claim 14, wherein:
an electric potential applied to the data signal line changes in sync with timing at which one of the on-pulse signals becomes in its off-state earlier than the other or after the timing.

17. The display device according to claim 7, wherein:
a polarity of an electric potential applied to the same data signal line is inverted for every horizontal period.

18. The display device according to claim 2, wherein:
said first switching element and said second switching element are connected to independent first and second data signal lines, respectively.

19. The display device according to claim 18, wherein:
said first luminance area and said second luminance area are formed by applying different signal electric potentials to the first and the second data signal lines, respectively.

20. An active matrix substrate comprising:
a plurality of pixel regions,
wherein each of the pixel regions includes:
a first switching element;
a second switching element;
a first sub-pixel electrode connected to the first switching element; and
a second sub-pixel electrode which surrounds the first sub-pixel electrode, and is connected to the second switching element.

21. The active matrix substrate according to claim 20, wherein:
said first switching element and said second switching element are connected to a same scan signal line.

22. The active matrix substrate according to claim 20, further comprising:
a single data signal line provided to each of the pixel regions, said first and second switching elements being connected to the single data signal line;
a first retentive capacity wiring, said first sub-pixel electrode and the first retentive capacity wiring defining capacitance; and
a second retentive capacity wiring, said second sub-pixel electrode and the second retentive capacity wiring defining capacitance.

23. The active matrix substrate according to claim 20, wherein:
independent first and second data signal lines are provided to the pixel regions, respectively;
the first data signal line is connected to the first switching element; and
the second signal line is connected to the second switching element.

24. The active matrix substrate according to claim 20, wherein:
a light-shielding body is provided so that the light-shielding body and a boundary area between the first sub-pixel electrode and the second sub-pixel electrode overlap each other.

25. The active matrix substrate according to claim 20, wherein:
a part of the wiring from the first switching element or the second switching element and a boundary area between the first sub-pixel electrode and the second sub-pixel electrode overlap each other.

26. The active matrix substrate according to claim 21, wherein:
a part of the scan signal line and a boundary area between the first sub-pixel electrode and the second sub-pixel electrode overlap each other.

27. The active matrix substrate according to claim 22, wherein:
a part of the first retentive capacity wiring and a boundary area between the first sub-pixel electrode and the second sub-pixel electrode overlap each other.

28. The active matrix substrate according to claim 26, wherein:
the scan signal line is wired in a middle part of a pixel in a frame shape so that the scan signal line and the boundary area overlap each other.

29. The active matrix substrate according to claim 27, wherein:
the first retentive capacity wiring is wired in a middle part of a pixel in a frame shape so that the first retentive capacity wiring and the boundary area overlap each other.

30. The display device according to claim 11, wherein:
increasing of the electric potential of the first retentive capacity wiring is in sync with decreasing of the electric potential of the second retentive capacity wiring; or
decreasing of the electric potential of the first retentive capacity wiring is in sync with increasing of the electric potential of the second retentive capacity wiring.

31. The display device according to claim 11, wherein:
increasing of the electric potential of the first retentive capacity wiring and decreasing of the electric potential of the second retentive capacity wiring are shifted by one horizontal period; or
decreasing of the electric potential of the first retentive capacity wiring and increasing of the electric potential of the second retentive capacity wiring are shifted by one horizontal period.

32. A display device comprising:
an active matrix substrate according to claim 20.

33. A display device comprising:
an active matrix substrate according to claim 20;
a back light radiating a plurality of colors in a time division; and
said display device performing a field sequential display.

34. A liquid crystal display device comprising:
a display device recited in claim 1.

35. A television receiver comprising:
a display device recited in claim 1; and
a tuner for receiving television broadcasting.
